(19) United States
(12) Patent Application Publication
(10) Pub. No.: US 2024/0026783 A1
(43) Pub. Date: Jan. 25, 2024

(54) HOT/COLD SENSOR DATA STORAGE SYSTEM AND METHOD

(71) Applicant: LYTT LIMITED, Middlesex (GB)

(72) Inventor: Pradyumna THIRUVENKATANATHAN, Twickenham, London (GB)

(73) Assignee: LYTT LIMITED, Middlexes (GB)

(21) Appl. No.: 18/024,124

(22) PCT Filed: Oct. 14, 2020
(86) PCT No.: PCT/EP2020/078967

§ 371 Date: Mar. 1, 2023

(51) Int. Cl. E21B 47/26; E21B 47/107; G01V 1/24

(52) U.S. Cl. CPC E21B 47/26; E21B 47/107; G01V 1/24; G01V 2210/32

(57) ABSTRACT

A method of reducing data storage volumes for event by identifying an anomaly in a first portion of a sensor data set using one or more features derived from the sensor data, wherein the sensor data set is obtained from a sensor, and wherein the sensor data set comprises a plurality of individual sensor readings through time, determining one or more signal characteristics of the first portion of the sensor data set; and storing, in a memory, the one or more signal characteristics of the first portion of the sensor data set, wherein a second portion of the sensor data does not contain the anomaly, and wherein the second portion of the sensor data is not stored in the memory.

### CROSS-REFERENCE TO RELATED APPLICATIONS

This application is a 35 U.S.C. § 371 national stage application of PCT/EP2020/078967 filed Oct. 14, 2020, entitled “Hot/Cold Sensor Data Storage System and Method,” which is hereby incorporated herein by reference in its entirety for all purposes.

### STATEMENT REGARDING FEDERALLY SPONSORED RESEARCH OR DEVELOPMENT

Not applicable.

### BACKGROUND

Various events can occur that can be monitored. For example, the movement of vehicles, the operation of equipment, and the flow of fluids can all be monitored using various types of sensors. In the context of a hydrocarbon production well, various fluids such as hydrocarbons, water, gas, and the like can be produced from the formation into the wellbore. The production of the fluid can result in the movement of the fluids in various downhole regions, including with the subterranean formation, from the formation into the wellbore, and within the wellbore itself. For example, some subterranean formations can release solids, generally referred to as “sand,” that can be produced along with the fluids into the wellbore.

Efforts have been made to detect and monitor the movement of various fluids including those with particles in them within the wellbore. For example, efforts to detect sand have been made using acoustic point sensors placed at the surface of the well and clamped onto the production pipe. Produced sand particles passing through the production pipe, along with the produced fluids (e.g., oil, gas or water), contact the walls of the pipe, especially at the bends and elbows of the production pipe. Such contact can create stress waves that are captured as sound signals by the acoustic sensors mounted on the pipe wall.

Detection and monitoring of events can involve massive amounts of data. Accordingly, methods of reducing data storage volumes for event detection are needed.

### SUMMARY

Herein disclosed is a method of reducing data storage volumes for event detection, the method comprising: identifying an anomaly in a first portion of a sensor data set using one or more features derived from the sensor data, wherein the sensor data set is obtained from a sensor, and wherein the sensor data set comprises a plurality of individual sensor readings through time; determining one or more signal characteristics of the first portion of the sensor data set; and storing, in a memory, the one or more signal characteristics of the first portion of the sensor data set, wherein a second portion of the sensor data does not contain the anomaly, and wherein the second portion of the sensor data is not stored in the memory.

Also disclosed herein is a system for reducing data storage volumes for event detection, the system comprising: a memory; a data reduction program stored in the memory; and a processor, wherein the data reduction program, when executed on the processor, configures the processor to: identifying an anomaly in a first portion of a sensor data set using one or more features derived from the sensor data, wherein the sensor data set is obtained from a sensor, and wherein the sensor data set comprises a plurality of individual sensor readings through time; determine one or more signal characteristics of the first portion of the sensor data set; store, in a memory, the one or more signal characteristics of the first portion of the sensor data set, wherein a second portion of the sensor data does not contain the anomaly, and wherein the second portion of the sensor data is not stored in the memory.

Further disclosed herein is a method of reducing data storage volumes for event detection, the method comprising: obtaining sensor data, wherein the sensor data is obtained from one or more sensors, and wherein the sensor data comprises measured sensor values through time and location; determining one or more signal characteristics of the sensor data, wherein the one or more signal characteristics comprise one or more features derived from the sensor data; storing the sensor data and the one or more signal characteristics of the sensor data at a first time; determining a difference value between the sensor data and the one or more signal characteristics at the first time and the sensor data and the one or more signal characteristics at a second time; and storing the difference value for the sensor data and the one or more signal characteristics for the second time.

Also disclosed herein is a system of reducing data storage volumes for event detection, the system comprising: a memory; a data reduction program stored in the memory; and a processor, wherein the data reduction program, when executed on the processor, configures the processor to: receive sensor data, wherein the sensor data is obtained from one or more sensors, and wherein the sensor data comprises measured sensor values through time and location; determine one or more signal characteristics of the sensor data, wherein the one or more signal characteristics comprise one or more features derived from the sensor data; store the sensor data and the one or more signal characteristics of the sensor data at a first time; determine a difference value between the sensor data and the one or more signal characteristics at the first time and the sensor data and the one or more signal characteristics at a second time; and store the difference value for the sensor data and the one or more signal characteristics for the second time.

Further disclosed herein is a method of reducing data storage volumes for event detection in wellbores, the method comprising: obtaining acoustic data within a wellbore, wherein the acoustic data comprises sensor readings for a plurality of depths along the wellbore and for a plurality of time periods; identifying an anomaly in a first portion of a sensor data set using one or more frequency domain features derived from the sensor data; storing, in a memory, the acoustic data and the one or more frequency domain features for a first time for the first portion of the sensor data set; determining a difference value for the acoustic data and the one or more frequency domain features between the first time and a second time; and storing, in the memory, the difference value for the second time.

Also disclosed herein is a system for reducing data storage volumes for event detection in wellbores, the system comprising: a memory; a data reduction program stored in the memory; and a processor, wherein the data reduction program, when executed on the processor, configures the processor to: receive acoustic data within the wellbore, wherein the acoustic data comprises sensor readings for a plurality of depths along the wellbore and for a plurality of time periods; identify an anomaly in a first portion of a sensor data set using one or more frequency domain features derived from the sensor data; store, in the memory, the acoustic data and the one or more frequency domain features for a first time for the first portion of the sensor data set; determine a difference value for the acoustic data and the one or more frequency domain features between the first time and a second time; and store, in the memory, the difference value for the second time.

These and other features will be more clearly understood from the following detailed description taken in conjunction with the accompanying drawings and claims.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A is a process flow diagram of a method of reducing data storage volumes for event detection according to embodiments of this disclosure.

FIG. 1B is a process flow diagram of identifying an anomaly in the first portion of the sensor data using the one or more features derived from the sensor data according to embodiments of this disclosure.

FIG. 1C is a process flow diagram of storing one or more signal characteristics of the first portion of the sensor data according to embodiments of this disclosure.

FIG. 1D is a process flow diagram of a method of reducing data storage volumes for event detection according to embodiments of this disclosure.

FIG. 1E is a process flow diagram of a method of reducing data storage volumes for event detection in a wellbore according to embodiments of this disclosure.

FIG. 2 is a schematic, cross-sectional illustration of a downhole wellbore environment according to an embodiment.

FIG. 3 illustrates an embodiment of a schematic processing flow for an acoustic signal.

FIG. 4 schematically illustrates a computer that can be used to carry out various steps according to an embodiment.

### DETAILED DESCRIPTION

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. Reference to up or down will be made for purposes of description with “up,” “upper,” “upward,” “upstream,” or “above” meaning toward the surface of the wellbore and with “down,” “lower,” “downward,” “downstream,” or “below” meaning toward the terminal end of the well, regardless of the wellbore orientation. Reference to inner or outer will be made for purposes of description with “in,” “inner,” or “inward” meaning towards the central longitudinal axis of the wellbore and/or wellbore tubular, and “out,” “outer,” or “outward” meaning towards the wellbore wall. As used herein, the term “longitudinal” or “longitudinally” refers to an axis substantially aligned with the central axis of the wellbore tubular, and “radial” or “radially” refer to a direction perpendicular to the longitudinal axis. The various characteristics mentioned above, as well as other features and characteristics described in more detail below, will be readily apparent to those skilled in the art with the aid of this disclosure upon reading the following detailed description of the embodiments, and by referring to the accompanying drawings.

Disclosed herein are systems and methods for reducing data storage volumes for event detection and presenting such data to a user. Such systems and methods for reducing data storage volumes for event detection will be provided below. Some specific systems and methods for data acquisition, preprocessing, frequency domain extraction, comparison with signatures/thresholds, and event identification, and auto-calibration/recalibration for use during frequency domain extraction and/or comparison with event signatures or thresholds are provided thereafter.

To avoid storing all of the data associated with a sensor, such as all of the raw data values obtained across time and depth for distributed acoustic sensor (DAS) or other logs, anomaly detection can be run on the data, in some aspects in real time, as described hereinbelow. The disclosed system can use a priori knowledge of the values stored to indicate the presence of one or more events. In embodiments, the data used to identify an anomaly and/or corresponding event may not be stored. The method can include denoising and/or thresholding the sensor data, performing an anomaly identification, optionally performing event identification, and storing only data (and/or features calculated therefrom) related to the anomaly and/or the event. Feature extraction can be utilized for the anomaly detection and/or event identification. Non-anomalous data can be discarded or not stored. In order to quickly and efficiently retrieve the data for presentation when recalled by a user, the sensor data may further be tiled across time or space to provide a higher level view. To further reduce the volume of sensor data stored, over time, the more detailed tiles can be discarded. Rounding can also be utilized to further reduce data storage volumes.

In embodiments, only the data with anomalies (e.g., a first portion of the data obtained from a sensor) may be stored, and the remaining data (e.g., a second portion of the sensor data that does not contain anomaly(ies)) may not be stored. Via this disclosure, should the non-anomalous data be recalled, this portion of the data can be displayed with zeros or another indicator of the absence of an anomaly or event. The absence of stored data can thus indicate a lack of any anomalies or events in that data. In other embodiments, events associated with the detected anomalies can be identified (e.g., using extraction of one or a plurality of features (e.g., frequency domain features, thermal features, etc.) from the first portion of the sensor data), and a corresponding feature, but not necessarily the one or more features utilized to identify the event, can be stored, for example, in a log of the data. For example, for detection of sand ingress events, a plurality of frequency domain features can be used to identify the presence of sand ingress, and once identified, only an acoustic amplitude, as an example, may be stored with time and depth data for the first portion of the data. The presence of a stored entry can then indicate that sand ingress was detected at the time and location stored, and the acoustic amplitude can be used to indicate an amount of sand ingress at the time and location. By storing only the first portion of the data containing the identified anomalies (or events), a significant reduction in overall data volumes being stored can be realized relative to methods that comprise storing in memory all of the sensor data (e.g., the raw data, data the second portion of the sensor data or all of the features utilized to detect anomalies and/or identify events). This can allow visualization of the data in real time or near real time as the amount of data can be more easily handled by visualization processes. In some aspects, the data can be viewed remotely as the amount of data is sufficiently reduced from the raw data to be transmitted or streamed in real time or near real time to a remote location for viewing, which may not be possible using a full data set obtained from the sensors in many settings due to bandwidth limitations.

Additional data reduction can be achieved by storing only changes in values. For example, initial values can be stored, and subsequently, only changes through time can be stored. Alternatively, only changes in another parameter (e.g., through depth) from a first reference parameter (e.g., depth) can be stored. In aspects, low frequency data can be stored, with between readings values stored as zeroes, constant values, or interpolated between readings, or data reported base on the least frequent data. As mentioned above, further data reduction can be achieved, in aspects, via rounding to limit a number of digits stored in a memory, and/or via storing of values without including zero values (e.g., for cold storage).

Presentation of the stored data can include presenting the data as it is stored, tiling to average the results through time and/or depth and store (e.g., data compression) to present a smaller data set, and/or repopulating zero values from a cold storage not storing zeroes to generate a data set for presentation.

As used herein, an anomaly can refer to the occurrence of an event in the data and an anomaly identification can refer to the identification of an occurrence in the data that is above a baseline value for the sensor, outside of the baseline, and/or a deviation from the baseline. For example, an anomaly may be identified when the signal output or one or more features within the signal output exceed a threshold, where the threshold can represent the baseline plus a variability threshold. In general, the anomaly may help to identify the occurrence of an event, but may not identify the event itself such that the anomaly could represent any number of potential events within the data. Anomaly detection can then be used to quickly identify portions of the data for further analysis such as event identification. The portions of the data that do not have identified anomalies may not be further analyzed and can be discarded from further processing in some aspects.

As used herein, an event can refer to a specific occurrence that can be identified from the signal output or data. Various methods of identifying the event can be used such as signature matching, machine learning models, and the like. In some aspects, event identification can use one or more features (e.g., frequency domain features, thermal features, etc.) derived from the data to identify a specific event. An event can then differ from an anomaly in that an anomaly may represent an unidentified event within the data, and an event represents an identified occurrence. Anomaly detection may be faster than event identification generally due to the use of fewer features for anomaly detection as opposed to feature extraction followed by more complicated processing for the identification of specific events, as described in more detail herein. In some aspects, anomaly detection can first be used to identify portions of the data containing potential events, and then event identification may only be carried out on the portions of the data identified as containing anomalies. This may help to improve the overall processing of the sensor data.

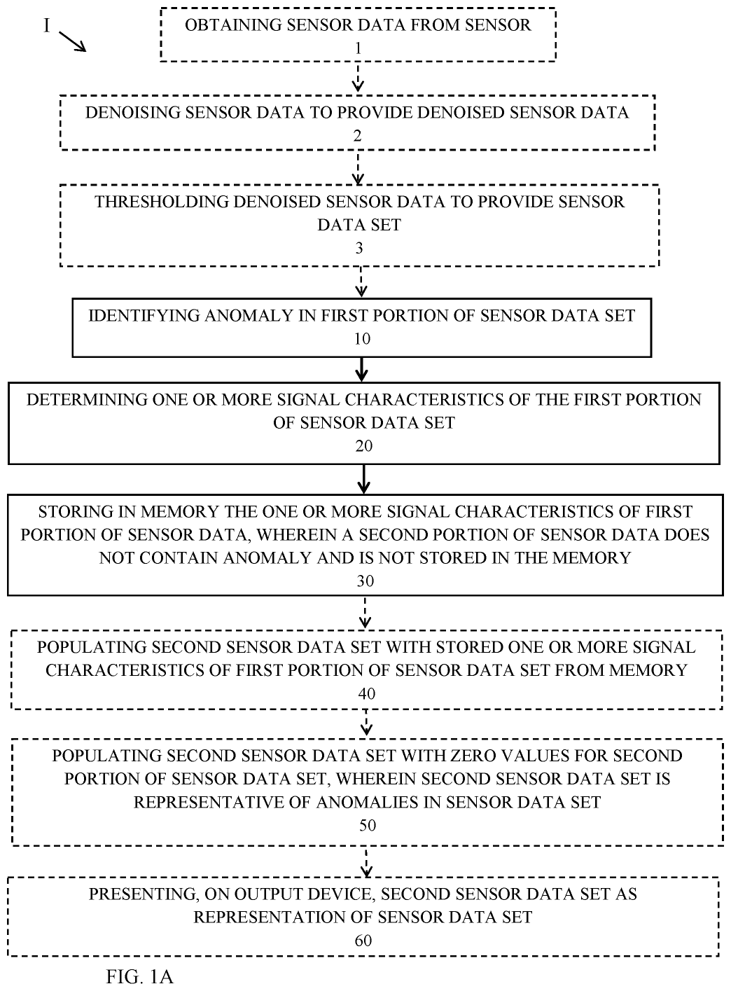

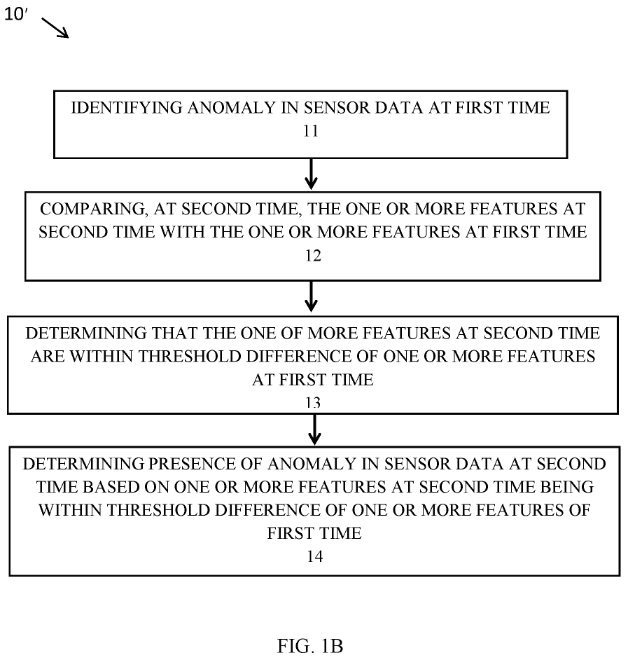

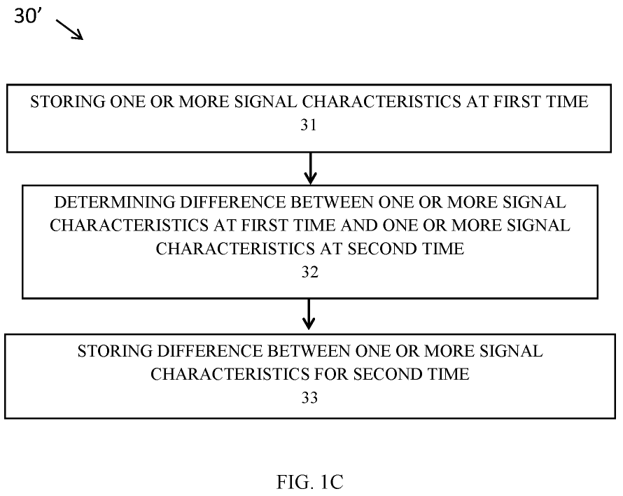

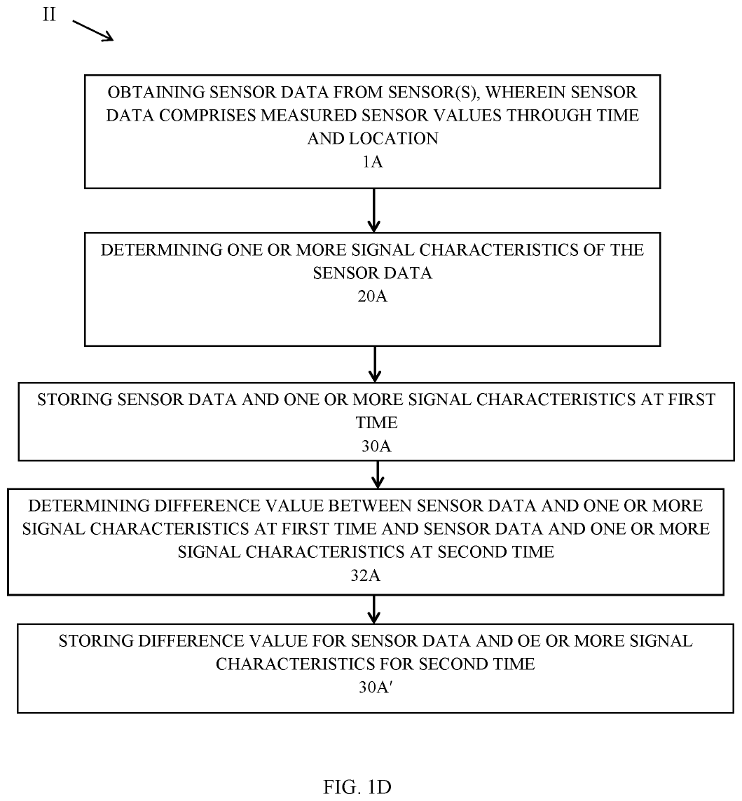

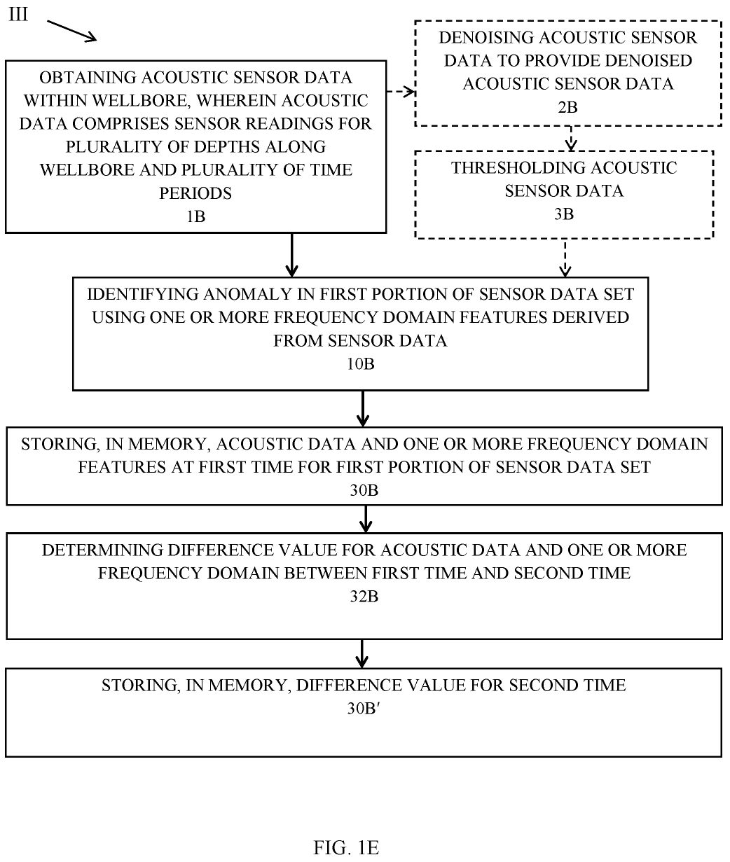

FIG. 1 is a process flow diagram of a method I of reducing data storage volumes for event detection according to embodiments of this disclosure. Method I comprises: identifying an anomaly in a first portion of a sensor data set 10. Identifying the anomaly can include using one or more features derived from the sensor data. The sensor data is obtained from a sensor, and can comprise a plurality of individual sensor readings through time. The sensor data set can comprise, for example and without limitation, an acoustic data set, a temperature data set, a pressure data set, a strain data set, or a flow data set. Method I further comprises: determining one or more signal characteristics of the first portion of the sensor data set 20, and storing, in a memory, the one or more signal characteristics of the first portion of the sensor data set 30. A second portion of the sensor data does not contain the anomaly, and is not stored in the memory. That is, according to this disclosure the second portion of the sensor data that does not contain an anomaly can be discarded/not stored, thus substantially reducing a volume of data being stored by the memory.

The one or more signal characteristics can comprise at least one of: a time, a locator, or an identifier associated with the first portion of the sensor data. In aspects, the one or more signal characteristics comprise one or more features derived from the first portion of the sensor data set, a time, a locator, or an amplitude of the first portion of the sensor data set.

As depicted in FIG. 1A, Method I can further comprise: obtaining sensor data from the sensor 1; denoising the sensor data to provide a denoised sensor data 2; and/or thresholding the denoised sensor data to provide the sensor data set 3. Thresholding the denoised sensor data 3 replaces a sensor data set value below a threshold with a zero value. The denoising of the sensor data to provide the denoised sensor data 2 can be effected by any methods known to those of skill in the art. For example and without limitation, denoising the sensor data 2 can comprise median filtering the sensor data, as described hereinbelow.

FIG. 1B is a process flow diagram of identifying an anomaly in the first portion of the sensor data 10′ using the one or more features derived from the sensor data according to embodiments of this disclosure. In FIG. 1B, identifying the anomaly in the first portion of a sensor data set 10′ using the one or more features derived from the sensor data comprises: identifying the anomaly in the sensor data set at a first time 11; comparing, at a second time, the one or more features at the second time with the one or more features at the first time 12; determining that the one or more feature at the second time are within a threshold difference of the one or more features at the first time 13; and determining the presence of the anomaly in the sensor data set at the second time based on the one or more feature at the second time being within the threshold difference of the one or more features at the first time 14.

FIG. 1C is a process flow diagram of storing one or more signal characteristics of the first portion of the sensor data 30′ according to embodiments of this disclosure. In FIG. 1C, storing the one or more signal characteristics of the first portion of the sensor data set 30′ comprises: storing the one or more signal characteristics at a first time 31; determining a difference between the one or more signal characteristic at the first time and the one or more signal characteristics at a second time 32; and storing the difference for the one or more signal characteristics for the second time 33. In aspects, the one or more signal characteristics can be stored at the first time for a first location, and the method can further comprise: determining a difference between the one or more signal characteristics at the first time and at the first location and the one or more signal characteristics at the first time and at a second location; and storing the difference for the one or more signal characteristics for the first time at the second location. In this manner, only differences can be stored.

As depicted in FIG. 1A, Method I can further comprise: populating a second sensor data set with the stored one or more signal characteristics of the first portion of the sensor data set from the memory 40; and populating the second sensor data set with zero values for the second portion of the sensor data set 50, wherein the second sensor data set is representative of the anomalies within the sensor data set. Method I can further comprise: presenting, on an output device, the second sensor data set as a representation of the sensor data set 60. In aspects, Method I can comprise generating one or more averaged data sets, wherein the averaged data sets average two or more readings from the second sensor data; and presenting, on the output device, at least one of the one or more averaged data sets. In this manner, the second data set can be produced via repopulation from the stored data when visualization of the data is requested, for example by a user.

In embodiments, anomaly identification is performed at 10, wherein sensor data, the raw sensor data obtained at 1, the denoised sensor data obtained at 2, the thresholded denoised sensor data obtained at 3, or one or more features obtained from processed sensor data is analyzed to detect an anomaly. In some embodiments, any of the sensor data, including raw or processed sensor data, can be obtained from the sensor and may be presented remote in time and/or location. For example, the sensor data can provided directly from the sensor or stored for some period and analyzed at a later time. Similarly, the sensor data, or a processed form thereof, may be transmitted to a remote location for further processing. For example, various compression routines such a lossless compression can be used to compress and transmit the data for remote processing. The compressed data can be received at a location remote from the original source (e.g., at a processing center), decompressed, and then processed as described herein. In some embodiments, the sensor data can be processed to obtain one or more features such as frequency domain features, temperature features, or the like, compressed using various communication protocols, and then re-expanded for subsequent processing as described herein. The use of an initial feature extraction step followed by compression and transmission may aid in transmitting the sensor data to a location suited for further processing and storing the sensor data and processing results.

Anomaly detection at can include analyzing the sensor data obtained at or the denoised and/or thresholded sensor data to determine whether or not one or more elements of the signal (e.g., one or more features, etc.) is above a baseline or threshold. Thus, performing anomaly detection can be effected on the raw data or the denoised and/or thresholded sensor data obtained by denoising at 2 and/or thresholding at 3, and can be performed via any methods known to those of skill in the art. In specific embodiments, performing anomaly detection on the sensor data comprises: determining a base sensor reading for the sensor data; and determining that the sensor data contains one or more sensor readings above a threshold deviation from the base sensor reading. The raw data obtained or the denoised and/or thresholded data can be analyzed, and, if there are no anomalies detected therein at anomaly detection at 10, that sensor data (e.g., the second portion of the sensor data) may not be stored. According to aspects of this disclosure, rather than storing zeroes or other values for the second portion of the data, no data is stored for the second portion of the data. In embodiments, when an anomaly is detected, a signal characteristic can be stored, and subsequent values stored can comprise only difference values (e.g., determined at 32), thus further reducing the total volume of stored data.

FIG. 1D is a process flow diagram of a Method II of reducing data storage volumes for event detection according to embodiments of this disclosure. Method II comprises: obtaining sensor data 1A, determining one or more signal characteristics of the sensor data 20A, storing the sensor data and the one or more signal characteristics of the sensor data at a first time 30A, determining a difference value between the sensor data and the one or more signal characteristics at the first time and the sensor data and the one or more signal characteristics at a second time 32A, and storing the difference value for the sensor data and the one or more signal characteristics for the second time 30A′. The sensor data can be obtained at 1A from one or more sensors, and can comprise measured sensor values through time and location. The one or more signal characteristics determined at 20A can comprise one or more features derived from the sensor data.

In aspects of Method II, the sensor data and the one or more signal characteristics can be stored at the first time for a first location, and the method can further comprise: determining a difference value between the sensor data and the one or more signal characteristics at the first time and at the first location and the sensor data and the one or more signal characteristics at the first time and at a second location; and storing the difference value for the sensor data and the one or more signal characteristics for the first time at the second location. Again, by storing the difference value, the amount of data stored can be reduced.

In aspects of the data reduction methods disclosed herein (e.g., Method I, Method II, or Method III, described hereinbelow with reference to FIG. 1E), further comprise rounding the difference value (e.g., the difference value for the sensor data and the one or more signal characteristics of Method II); and storing the rounded difference value for the sensor data and the one or more signal characteristics. Rounding the difference value prior to storage can provide further data reduction, in aspects.

Method II can further comprise a step similar to 10 of Method I comprising: identifying an anomaly in a first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, and wherein a second portion of the sensor data does not contain the anomaly, and wherein the second portion of the sensor data is not stored in the memory. Alternatively, zeroes can be stored for the second portion of the data, in which aspects, Method II can comprise: identifying the anomaly in a first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, wherein the second portion of the sensor data does not contain the anomaly, and wherein only zero values are stored for the second portion of the sensor data. In such latter aspects, Method II can further comprise: identifying zero values within the stored data; and removing the zero values from the stored data.

When data retrieval is desired, Method II can further comprise steps similar to steps 40, 50, and 60 of Method I, whereby the method can include populating a sensor data set with the stored one or more signal characteristics of the first portion of the sensor data from the memory; and populating the sensor data set with zero values for the second portion of the sensor data (if zeroes haven't been stored), wherein the sensor data set is representative of the anomalies within the sensor data. Method II can also include presenting, on an output device, the sensor data set as a representation of the sensor data. As with Method I, Method II can include generating one or more averaged data sets, wherein the averaged data sets average two or more readings from the sensor data set; and presenting, on the output device, at least one of the one or more averaged data sets.

FIG. 1E is a process flow diagram of a Method III of reducing data storage volumes for event detection in a wellbore according to embodiments of this disclosure. Method III comprises: obtaining acoustic data within the wellbore 1, identifying an anomaly in a first portion of a sensor data set using one or more frequency domain features derived from the sensor data 10B, storing, in a memory, the acoustic data and the one or more frequency domain features for a first time for the first portion of the sensor data set 30B, determining a difference value for the acoustic data and the one or more frequency domain features between the first time and a second time 32B; and storing, in the memory, the difference value for the second time 30B′. The acoustic data can comprise sensor readings for a plurality of depths along the wellbore and for a plurality of time periods.

In aspects of Method III, the acoustic data and the one or more frequency domain features are stored for the first time and a first depth for the first portion of the sensor data set, and the method further comprises: determining a depth difference value for the acoustic data and the one or more frequency domain features between: 1) the first time and the first depth, and 2) the first time and a second depth, wherein storing the acoustic data and the one or more frequency domain features at 30B comprises storing the depth difference value for the first time and the second depth.

Method III can further include denoising the acoustic data 2B to provide a denoised acoustic data and/or thresholding the denoised acoustic data 3B, prior to identifying the anomaly at 10B. As noted hereinabove with reference to Method I, denoising 2B can be effected by any methods known to those of skill in the art. In aspects, denoising 2B comprises median filtering the acoustic data. Thresholding the denoised acoustic data 3B can be utilized to replace acoustic sensor data values below a threshold with a zero value.

In a similar manner as with reference to Method I in FIG. 1B, identifying the anomaly in the first portion of the data set using the one or more frequency domain features derived from the sensor data 10B can comprise: identifying the anomaly in the sensor data set at a first time; comparing, at a second time, the one or more features at the second time with the one or more features at the first time; determining that the one or more feature at the second time are within a threshold difference of the one or more features at the first time; and determining the presence of the anomaly in the sensor data set at the second time based on the one or more feature at the second time being within the threshold difference of the one or more features at the first time.

In a similar manner as described with reference to steps 40, 50, 60 of Method I in FIG. 1A, Method III can further comprise: populating a second sensor data set with the stored frequency domain features of the first portion of the sensor data set from the memory; populating the second sensor data set with zero values for the second portion of the sensor data set, wherein the second sensor data set is representative of the anomalies within the sensor data set, and/or presenting, on an output device, the second sensor data set as a representation of the sensor data set. Also as described hereinabove with reference to Method I, Method III can also further include generating one or more averaged data sets, wherein the averaged data sets average two or more readings from the second sensor data; and presenting, on the output device, at least one of the one or more averaged data sets.

The one or more frequency domain features can comprise at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof. These frequency domain features are described further hereinbelow.

The method of reducing data storage volumes for event identification according to this disclosure can further comprise identifying an event in the first portion of the sensor data. Identifying events utilizing frequency domain features and/or temperature features can be performed substantially as described in U.S. Patent Publication No. 2020/0174149, entitled, “Event Detection Using DAS Features with Machine Learning” and filed on Nov. 27, 2019, U.S. Patent Publication No. 2020/0190971, entitled, “Distributed Acoustic Sensing Autocalibration” and filed on Dec. 11, 2019, or International Patent Application No. PCT/EP2020/051817 entitled “Event Characterization Using Hybrid DAS/DTS Measurements” [3239-08800] and filed on 24 Jan. 2010, the disclosure of each of which is hereby incorporated herein for reference in its entirety for all purposes.

In aspects, when an anomaly is detected (and only for those portions where an anomaly is detected, i.e., the first portion of the sensor data), feature analysis can be utilized to identify the event. For example, in applications, the sensor data comprises acoustic data, such as DAS data, and frequency domain features from the first portion of the sensor data can be utilized with machine learning models to identify an event at 35, as described in U.S. Patent Publication No. 2020/0190971. In aspects, a characteristic of the event can be stored along with the identification (e.g., time and location), and everything else (including the features (e.g., frequency domain features) used to identify the event) can be discarded/not stored. As an example, a spectral amplitude can be the feature retained for sand ingress to identify the extent (e.g., magnitude) of the sand entering a wellbore. The feature or identifier (e.g., spectral amplitude) that is stored to indicate the extent of the event may not be a feature (e.g., a frequency domain feature) that was utilized to identify the event.

Conventional methods of storing all of the raw sensor data obtained at 1/1A/1B for each channel (e.g., a depth resolution range) at each sample time during event identification can require terabytes of storage per hour. Running feature algorithms for each time and location (e.g., each depth along a fiber optic cable) to generate feature sets for each time at each channel (e.g., along the fiber) can reduce the data load by about 2000 times. According to this disclosure, sensor data and/or features utilized to perform anomaly detection on the sensor data at 10/10B, are not stored for the second portion of the sensor data; any sensor data or features utilized to identify the anomaly in the first portion of the sensor data may or may not be stored as the signal characteristic, along with the time and location of the identified anomaly or event. Accordingly, a substantial reduction in data being stored relative to storing of all the sensor data or features utilized to identify can be realized via the method of this disclosure. In embodiments, for only the first portion of the sensor data where anomalies are detected at 10 (i.e., and not for the sensor data of the second portion where anomalies are not detected at 10, event detection algorithms can be run to identify an event and only an indication or identifier of the event and optionally a characteristic for the extent of the event stored, with all other sensor data and/or derived features not stored. For example, a reduction in the data stored provided by the herein disclosed method can reduce the data storage load by at least one, two, three, four, five, six, seven, eight, nine, or ten thousand times or more relative to methods for which sensor data and/or features are stored for both the first portion of the data in which anomalies are detected at 10 and the second portion of the sensor data in which anomalies are not detected at 10.

As described above, the method of reducing data volumes for event detection can further comprise: presenting, on an output device, the second sensor data set as representative of the sensor data set, and optionally presenting a zero, null, or other absence indicator value (i.e., an indicator value for indicating absence of an anomaly or event) on the output device for the second portion of the sensor data set at 60. As the sensor data without an anomaly (e.g., the sensor data of the second portion of the sensor data) may not have been stored, if the data is being reconstructed, a null value or missing data (i.e., times and locations for which no data is stored) can be backfilled with zero values or some other indicator value to indicate the absence of an anomaly (or event) for that time and location. The reduced data set stored allows for quick viewing of stored data.

As noted above, in embodiments, the method comprises generating one or more averaged data sets, wherein the averaged data sets average two or more readings from the second sensor data, and presenting, on the output device, at least one of the one or more averaged data sets. This averaging, or “tiling” can thus provide a plurality of data sets (or “tiles”), wherein each data set of the plurality of data sets comprises an average of the first portion of the sensor data. Tiling can comprise, rather than just using time based data, creating a plurality of data sets per time interval (per the reading time interval). For example, a first data set can be created at the original resolution in depth (e.g., every meter of sensor data, when sensor data is obtained every meter), a second data set created at a lower resolution (e.g., an average across every 5 meters of sensor data), and so on, up to a very high level data set (e.g., an average across every 100 meters of sensor data). The higher level data sets or “tiles” contain less data since the averaging reduces the total data load in that tile. When called upon in a viewer, the higher level tiles can be displayed first. When a user requests a finer resolution, the amount of data being requested would be limited, and, since the plurality of data sets or tiles are already stored, the requested data can be more readily available (e.g., no processing time is needed to create it upon request, as the plurality of tiles are already stored in memory). Alternatively or additionally, data on a time basis can be utilized to create tiles (e.g., a fine resolution first tile containing data every 1 second, a second tile containing data averaged over every 2 seconds, a third tile containing data averaged over 5 seconds, etc.). Via tiling, the access time for accessing stored data can be reduced; however, as there are then multiple data sets for each original set of data, the total stored data load (e.g., the total volume of data storage) is increased via tiling. In embodiments of the method employing such tiling, the more specific data sets or tiles can be deleted from storage over time, whereby only higher level tiles (e.g., tiles averaged over larger amounts of time or space) are stored/maintained for the old data. As there can still be a lot of data stored, some of the more recent data (e.g., more recent sensor data, features, indicators, and/or tiles) can be kept in “warm” storage that can be easily accessed, while the older data can be kept in “cold” storage that takes longer to access. For example, in embodiments, data can be moved to cold storage when it is 1, 2, 3, 4, 5, 6, 7, 8, 9, 10, 11, or 12 months old or older.

A system for reducing data storage volumes for event detection can comprise: a memory; a data reduction program stored in the memory; and a processor, wherein the data reduction program, when executed on the processor, configures the processor to: identifying an anomaly in a first portion of a sensor data set using one or more features derived from the sensor data, wherein the sensor data set is obtained from a sensor, and wherein the sensor data set comprises a plurality of individual sensor readings through time; determine one or more signal characteristics of the first portion of the sensor data set; and store, in a memory, the one or more signal characteristics of the first portion of the sensor data set, wherein a second portion of the sensor data does not contain the anomaly, and wherein the second portion of the sensor data is not stored in the memory. The sensor data set can comprise an acoustic data set, a temperature data set, a pressure data set, a strain data set, or a flow data set.

As described hereinabove with reference to FIG. 1A to FIG. 1E, the one or more signal characteristics can comprise at least one of: a time, a locator, or an identifier associated with the first portion of the sensor data. The one or more signal characteristics can comprise one or more features derived from the first portion of the sensor data set, a time, a locator, or an amplitude of the first portion of the sensor data set.

In aspects, the processor is further configured to: receive sensor data from the sensor; denoise the sensor data to provide a denoised sensor data; and threshold the denoised sensor data to provide the sensor data set, wherein thresholding the denoised sensor data replaces a sensor data set value below a threshold with a zero value. In aspects, the processor is configured to denoise the sensor data by median filtering the sensor data. The processor can be configured for identifying the anomaly in the first portion of a sensor data set using the one or more features derived from the sensor data, as described with reference to FIG. 1B, by: identifying the anomaly in the sensor data set at a first time; comparing, at a second time, the one or more features at the second time with the one or more features at the first time; determining that the one or more feature at the second time are within a threshold difference of the one or more features at the first time; and determining the presence of the anomaly in the sensor data set at the second time based on the one or more feature at the second time being within the threshold difference of the one or more features at the first time.

As described with reference to FIG. 1C, storing the one or more signal characteristics of the first portion of the sensor data set comprises: storing the one or more signal characteristics at a first time; determining a difference between the one or more signal characteristic at the first time and the one or more signal characteristics at a second time; and storing the difference for the one or more signal characteristics for the second time.

In aspects, the one or more signal characteristics are stored at the first time for a first location, and the processor is further configured to: determine a difference between the one or more signal characteristics at the first time and at the first location and the one or more signal characteristics at the first time and at a second location; and store the difference for the one or more signal characteristics for the first time at the second location.

With reference to FIG. 1A, the processor can be further configured to: populate a second sensor data set with the stored one or more signal characteristics of the first portion of the sensor data set from the memory; and populate the second sensor data set with zero values for the second portion of the sensor data set, wherein the second sensor data set is representative of the anomalies within the sensor data set. The system can further comprise an output device, for example, configured for presenting the second sensor data set as a representation of the sensor data set. The processor can be further configured for tiling, as described hereinabove, In such aspects, the processor can be configured to: generate one or more averaged data sets, wherein the averaged data sets average two or more readings from the second sensor data; and present, on the output device, at least one of the one or more averaged data sets.

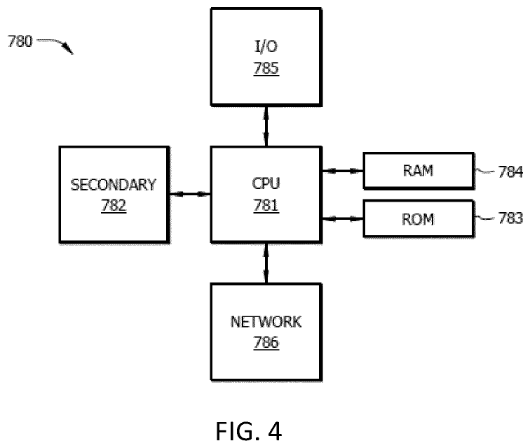

An exemplary computer system 780 comprising such a memory (RAM 784, ROM 783), central processing unit or processor 781, storage 782, and input/output 785 is described hereinbelow with reference to FIG. 4.

As noted above and detailed further hereinbelow, the sensor data can comprise acoustic data. In such embodiments, the processor can be further configured to: determine, as signal characteristics, a plurality of frequency domain features (e.g., as detailed further hereinbelow) in the first portion of the sensor data set. An identity of an event can be determined based on the plurality of frequency domain features (e.g., as detailed further hereinbelow). The plurality of frequency domain features can comprise at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof.

In embodiments, a system of reducing data storage volumes for event detection (e.g., operable to carry out Method II of FIG. 1D) comprises: a memory; a data reduction program stored in the memory; and a processor, wherein the data reduction program, when executed on the processor, configures the processor to: receive sensor data, wherein the sensor data is obtained from one or more sensors, and wherein the sensor data comprises measured sensor values through time and location; determine one or more signal characteristics of the sensor data, wherein the one or more signal characteristics comprise one or more features derived from the sensor data; store the sensor data and the one or more signal characteristics of the sensor data at a first time; determine a difference value between the sensor data and the one or more signal characteristics at the first time and the sensor data and the one or more signal characteristics at a second time; and store the difference value for the sensor data and the one or more signal characteristics for the second time. The sensor data and the one or more signal characteristics can be stored at the first time for a first location, and the processor can be further configured to: determine a difference value between the sensor data and the one or more signal characteristics at the first time and at the first location and the sensor data and the one or more signal characteristics at the first time and at a second location; and store the difference value for the sensor data and the one or more signal characteristics for the first time at the second location. The processor can be further configured to: round the difference value for the sensor data and the one or more signal characteristics; and store the rounded difference value for the sensor data and the one or more signal characteristics.

In embodiments, the processor is further configured to: identify an anomaly in a first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, and wherein a second portion of the sensor data does not contain the anomaly, and wherein the processor is further configured not to store the second portion of the sensor data in the memory. Alternatively, in aspects, the processor is further configured to: identify the anomaly in the first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, and wherein a second portion of the sensor data does not contain the anomaly, and wherein the processor is further configured to store in the memory only zero values for the second portion of the sensor data. In such latter aspects, the processor can be further configured to: identify zero values within the stored data; and remove the zero values from the stored data.

When called for, for example by a user, the processor can be further configured to: populate a sensor data set with the stored one or more signal characteristics of the first portion of the sensor data from the memory; and populate the sensor data set with zero values for the second portion of the sensor data, wherein the sensor data set is representative of the anomalies within the sensor data. In such aspects, the system can further include an output device, and the processor can be further configured to: present, on the output device, the sensor data set as a representation of the sensor data.

The processor can be further configured to provide tiling, for example, by generating one or more averaged data sets, wherein the averaged data sets average two or more readings from the sensor data set; and present, on the output device, at least one of the one or more averaged data sets.

In embodiments, a system of reducing data storage volumes for event detection in a wellbore (e.g., operable to carry out Method III of FIG. 1E) comprises: a memory; a data reduction program stored in the memory; and a processor, wherein the data reduction program, when executed on the processor, configures the processor to: receive acoustic data within the wellbore, wherein the acoustic data comprises sensor readings for a plurality of depths along the wellbore and for a plurality of time periods; identify an anomaly in a first portion of a sensor data set using one or more frequency domain features derived from the sensor data; store, in the memory, the acoustic data and the one or more frequency domain features for a first time for the first portion of the sensor data set; determine a difference value for the acoustic data and the one or more frequency domain features between the first time and a second time; and store, in the memory, the difference value for the second time.

The processor can be configured to store the acoustic data and the one or more frequency domain features for the first time and a first depth for the first portion of the sensor data set, and be further configured to: determine a depth difference value for the acoustic data and the one or more frequency domain features between: 1) the first time and the first depth, and 2) the first time and a second depth, and store the acoustic data and the one or more frequency domain features by storing the depth difference value for the first time and the second depth.

As described hereinabove, the processor can be further configured to: denoise the acoustic data to provide a denoised acoustic data prior to identifying the anomaly and/or to threshold the denoised acoustic data, by replacing sensor data values below a threshold with a zero value. In aspects, the processor is configured to denoise the acoustic data by median filtering the acoustic data.

In aspects of the system, the processor can be configured to identify the anomaly in the first portion of the data set using the one or more frequency domain features derived from the acoustic data by: identifying the anomaly in the acoustic data set at a first time; comparing, at a second time, the one or more features at the second time with the one or more features at the first time; determining that the one or more feature at the second time are within a threshold difference of the one or more features at the first time; and determining the presence of the anomaly in the acoustic data set at the second time based on the one or more feature at the second time being within the threshold difference of the one or more features at the first time.

Again, the processor can be further configured to: populate a second sensor data set with the stored frequency domain features of the first portion of the sensor data set from the memory; and populate the second sensor data set with zero values for the second portion of the sensor data set, wherein the second sensor data set is representative of the anomalies within the sensor data set. An output device can be included in the system, such that the processor can be further configured to: present, on the output device, the second sensor data set as a representation of the sensor data set. The processor can be further configured to: generate one or more averaged data sets, wherein the averaged data sets average two or more readings from the second sensor data; and present, on the output device, at least one of the one or more averaged data sets.

In specific aspects of the system for reducing data storage volumes for event detection in a wellbore, the one or more frequency domain features comprise at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof. As described further hereinbelow, the sensor readings can be obtained from a distributed acoustic sensor (DAS), which can comprise a fiber optic cable disposed within the wellbore.

In aspects, as noted hereinabove, the sensor data comprises acoustic data. A description of a real time signal processing architecture and auto-calibration/recalibration thereof allowing for the identification of various events that can be identified using acoustic signal data, such as DAS data is provided below. The event identification can comprise data acquisition of acoustic signals 1, pre-processing, extraction of one or more frequency domain features, comparison of the extracted frequency domain feature(s) with event signatures or thresholds, and event identification. As described hereinabove, according to this disclosure, anomaly detection can be performed at 10 to determine the first portion of the DAS data where an anomaly is detected. The feature extraction described further hereinbelow can be utilized only on this first portion of the DAS data to identify the event associated with the anomaly identified at 10, in embodiments. Alternatively, feature extraction can be utilized in performing anomaly detection at 10 on all the raw sensor data obtained at 1 and/or all the denoised data obtained at 2 or thresholded data obtained at 3, and only data regarding the identified anomalies stored in the memory.

Acoustic signals can be obtained from various locations or systems and used to identify and monitor various events. For example, acoustic sensors can be used to monitor events across an area or line. For example, a series of point source sensors (e.g., microphones) can be connected in a line or distributed through an area being monitored. When a fiber is used as in the DAS system, the fiber can pass along a line or path. For example, the fiber can pass through a pipeline, along a rail, a fence, or the like. In some aspects, the fiber is not limited to passing in a straight line and can pass in a non-linear manner throughout an area. For example, a single fiber can pass from one piece of equipment to the next when equipment is being monitored. Thus, as described herein, an acoustic sensor system can be used to obtain an acoustic sample from throughout an area or along a sensor path, which may not be a linear path in all aspects.

When the acoustic sensor or sensors are distributed throughout an area, a given acoustic sample can be obtained from more than one sensor. For example, when the distributed acoustic sensor comprises a plurality of point type acoustic sensors distributed over an area, an acoustic sample can be obtained from one particular point source sensor or across a plurality of the sensors. For example, an acoustic sample can be combined across various sensors, which can include in some aspects accounting for time of flight of sound between the individual sensors. The use of a plurality of sensors may provide an acoustic sample that allows for area effects to be taken into account in the spectral feature extraction process. For example, temporal and spatial effects can be taken into account when multiple acoustic samples for a given event are measured across an area or path.

Thus, acoustic signals in industries such as the transport industry (rail, traffic), security (perimeter security, pipeline monitoring), facilities monitoring (monitoring equipment such as electric submersible pumps, wind turbines, compressors), building monitoring, and the like can benefit from the use of the systems disclosed herein. For example, a rail line can be monitored to detect acoustic signals along the length of a rail, using for example, a fiber connected to the rail (either directly such as by attaching the fiber to the rail itself, or indirectly such as by arranging the fiber below the rail), along with a DAS unit. The length of the fiber along the rail can be considered a path of the fiber as it passes from the receiver/generator (e.g., the DAS unit) along the rail. Various acoustic signatures such as rail movements, maintenance vehicle movement, traffic movement, pedestrian traffic, and the like can be detected based on acoustic signals originating along the length of the rail and/or fiber. These signals can be processed to extract one or more spectral features, and spectral signatures of such events can be determined or developed. Once obtained, the spectral signatures can be used to process acoustic signals at various lengths along the path of the fiber and determine the presence of the various events using the spectral features and spectral signatures.

Similarly, security systems can use distributed acoustic sensors (e.g., a fiber, individual acoustic sensors, etc.) to detect acoustic signals across a path or an area. Various security related events such as voices, footsteps, breaking glass, etc. can be detected by using the acoustic signals from the acoustic sensors and processing them to extract spectral features and compare those spectral features to spectral signals for various security related events.

Similarly, the acoustic monitoring techniques can be used with point source, which can be individual or connected along a path. For example, a facility having industrial equipment can be monitored using the acoustic monitoring techniques described herein. For example, a facility having any rotating equipment such as pumps, turbines, compressors, or other equipment can have an acoustic sensor monitoring the piece of equipment. Spectral signatures of various events can be determined for each type of equipment and used to monitor and identify the state of the equipment. For example, a pump can be monitored to determine if the pump is active or inactive, if fluid is flowing through the pump, if a bearing is bad, and the like all through the use of an acoustic sample and the spectral characteristic matching as described herein. When multiple pieces of equipment are present, a single acoustic sensor such as a fiber can be coupled to each piece of equipment. This configuration may allow a single interrogation unit to monitor multiple pieces of equipment using the spectral analysis by resolving a length along the fiber for each piece of equipment. Thus, a monitoring system 110 (e.g., comprising a distributed acoustic monitoring system or a distributed temperature monitoring system, as described hereinbelow) may not require multiple processors correlating to individual pieces of equipment.

Similarly, pipelines can be monitored in a manner similar to the way the wellbores are monitored as disclosed herein. In this embodiment, the fiber may detect various events such as leaks, flow over a blockage or corrosion, and the like. This may allow for remote monitoring along the length of a pipeline.

Other types of industries can also benefit from the use of acoustic sensors to obtain acoustic samples that can be analyzed and matched to events using spectral feature extraction. Any industry that experiences events that create acoustic signals can be monitored using the systems as described herein.

An embodiment of a method for detecting an event can begin with an acoustic sensor such as a DAS system (e.g., as described in more detail below) obtaining, detecting, and/or receiving an acoustic signal at 1, for example, from an optical fiber placed in a location of interest. The raw optical data from the acoustic sensor can be received and generated by the sensor coupled to the optical fiber to produce the acoustic signal. The data generated by the sensor can be denoised at 2 to produced denoised data, which can optionally be thresholded at 3. Anomaly identification as described above can be performed at 10 on the raw data obtained at 1 or the denoised and/or thresholded data obtained at 2 and/or 3, and an anomaly identified in the first portion of the sensor data set at 10. The sensor data in the first portion can be can be stored in a memory for further processing. The event identification described below can be utilized to identify an event in the first portion of the sensor data.

The raw data can be optionally pre-processed using a number of optional steps. For example, a spatial sample point filter can be applied to allow a specific location along the length of the fiber to be isolated for further analysis. The pre-processing step may also include removal of spurious back reflection type noises at specific lengths along the fiber through spatial median filtering or spatial averaging techniques. The filtered data can be transformed from the time domain into the frequency domain using a transform such as a Fourier transform (e.g., a Short time Fourier Transform or through Discrete Fourier transformation). By transforming the data after applying the spatial filter, the amount of data processed in the transform can be reduced. A noise normalization routine can be performed on the data to improve the signal quality.

After the acoustic signal is pre-processed, the sample data set can be used in an optional spectral conformance check process or routine. The spectral conformance check can compare the frequency domain features to thresholds or levels to verify if the signal, or the portion of the signal being analyzed, represents an event of interest as opposed to a background signal representing noise. When the signal contains one or more frequency domain features and/or combinations of frequency domain features, the signal can be further processed to determine an identity of the event.

The event identity can be determined by comparing a plurality of frequency domain features and/or combinations thereof with one or more event signatures. The event signatures can comprise ranges, formula, thresholds, or other mathematical expressions describing values or the plurality of frequency domain features and/or combinations thereof for different types of events. For example, flow within a conduit can have a first set of values or formulas defining the fluid flow, motion along a path can have a different set of values or formulas defining a motion event, and different wellbore events can have still other sets of values or formulas defining different wellbore events. The at least one frequency domain feature can comprise any of the frequency domain features described herein in more detail. For example, in some embodiments, the at least one frequency domain feature includes one or more of a spectral roll-off, a spectral skewness, an RMS band energy, a total RMS energy, a spectral flatness, a spectral slope, a spectral kurtosis, a spectral flux, or a spectral autocorrelation function.

Systems and methods for data acquisition, preprocessing, frequency domain extraction, comparison with signatures/thresholds, and event identification will be described hereinbelow. As used herein, the term “real time” refers to a time that takes into account various communication and latency delays within a system, and can include actions taken within about ten seconds, within about thirty seconds, within about a minute, within about five minutes, or within about ten minutes of the action occurring. Various sensors (e.g., distributed fiber optic acoustic sensors, etc.) can be used to obtain an acoustic sampling at various points along the wellbore. The acoustic sample can then be processed using signal processing architecture with various feature extraction techniques (e.g., spectral feature extraction techniques) to obtain a measure of one or more frequency domain features that enable selectively extracting the acoustic signals of interest from background noise and consequently aiding in improving the accuracy of the identification of the movement of fluids and/or solids (e.g., sand ingress locations, gas influx locations, constricted fluid flow locations, etc.) in real time. As used herein, various frequency domain features can be obtained from the acoustic signal, and in some contexts the frequency domain features can also be referred to as spectral features or spectral descriptors.

The ability to identify various events in the wellbore may allow for various actions (e.g., remediation procedures) to be taken in response to the events. For example, a well can be shut in, production can be increased or decreased, and/or remedial measures can be taken in the wellbore, as appropriate based on the identified event(s). An effective response, when needed, benefits not just from a binary yes/no output of an identification of in-well events but also from a measure of relative amount of fluids and/or solids (e.g., concentrations of sand, amount of gas inflow, amount of fluid flow past a restriction, etc.) from each of the identified zones so that zones contributing the greatest fluid and/or solid amounts can be acted upon first to improve or optimize production. For example, when a leak is detected past a restriction, a relative flow rate of the leak may allow for an identification of the timing in working to plug the leak (e.g., small leaks may not need to be fixed, larger leaks may need to be fixed with a high priority, etc.).

As described herein, spectral descriptors can be used with DAS acoustic data processing in real time to provide various downhole surveillance applications. More specifically, the data processing techniques can be applied for various for downhole fluid profiling such as fluid inflow/outflow detection, fluid phase segregation, well integrity monitoring, in well leak detection (e.g., downhole casing and tubing leak detection, leaking fluid phase identification, 4 etc.), annular fluid flow diagnosis; overburden monitoring, fluid flow detection behind a casing, fluid induced hydraulic fracture detection in the overburden, and the like. Application of the signal processing technique with DAS for downhole surveillance provides a number of benefits including improving reservoir recovery by monitoring efficient drainage of reserves through downhole fluid surveillance (well integrity and production inflow monitoring), improving well operating envelopes through identification of drawdown levels (e.g., gas, sand, water, etc.), facilitating targeted remedial action for efficient sand management and well integrity, reducing operational risk through the clear identification of anomalies and/or failures in well barrier elements.

In some embodiments, use of the systems and methods described herein may provide knowledge of the zones contributing to fluid inflow and/or sanding and their relative concentrations, thereby potentially allowing for improved remediation actions based on the processing results. The methods and systems disclosed herein can also provide information on the variability of the amount of fluid and/or sand being produced by the different sand influx zones as a function of different production rates, different production chokes, and downhole pressure conditions, thereby enabling choke control (e.g., automated choke control) for controlling sand production.

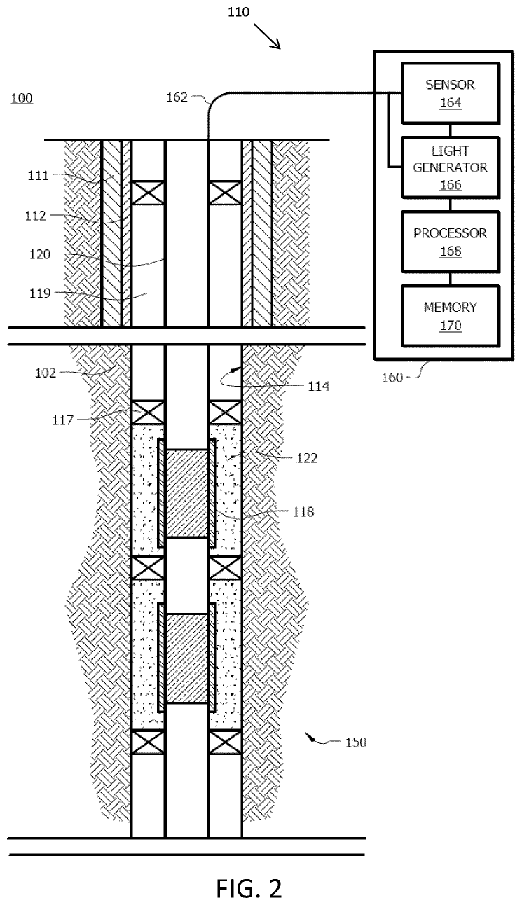

Referring now to FIG. 2, an example of a wellbore operating environment 100 is shown. As will be described in more detail below, embodiments of completion assemblies comprising distributed acoustic sensor (DAS) system in accordance with the principles described herein can be positioned in environment 100.

As shown in FIG. 2, exemplary environment 100 includes a wellbore 114 traversing a subterranean formation 102, casing 112 lining at least a portion of wellbore 114, and a tubular 120 extending through wellbore 114 and casing 112. A plurality of spaced screen elements or assemblies 118 are provided along tubular 120. In addition, a plurality of spaced zonal isolation device 117 and gravel packs 122 are provided between tubular 120 and the sidewall of wellbore 114. In some embodiments, the operating environment 100 includes a workover and/or drilling rig positioned at the surface and extending over the wellbore 114.

In general, the wellbore 114 can be drilled into the subterranean formation 102 using any suitable drilling technique. The wellbore 114 can extend substantially vertically from the earth's surface over a vertical wellbore portion, deviate from vertical relative to the earth's surface over a deviated wellbore portion, and/or transition to a horizontal wellbore portion. In general, all or portions of a wellbore may be vertical, deviated at any suitable angle, horizontal, and/or curved. In addition, the wellbore 114 can be a new wellbore, an existing wellbore, a straight wellbore, an extended reach wellbore, a sidetracked wellbore, a multi-lateral wellbore, and other types of wellbores for drilling and completing one or more production zones. As illustrated, the wellbore 114 includes a substantially vertical producing section 150, which is an open hole completion (i.e., casing 112 does not extend through producing section 150). Although section 150 is illustrated as a vertical and open hole portion of wellbore 114 in FIG. 1, embodiments disclosed herein can be employed in sections of wellbores having any orientation, and in open or cased sections of wellbores. The casing 112 extends into the wellbore 114 from the surface and is cemented within the wellbore 114 with cement 111.

Tubular 120 can be lowered into wellbore 114 for performing an operation such as drilling, completion, workover, treatment, and/or production processes. In the embodiment shown in FIG. 1, the tubular 120 is a completion assembly string including a distributed acoustic sensor (DAS) sensor coupled thereto. However, in general, embodiments of the tubular 120 can function as a different type of structure in a wellbore including, without limitation, as a drill string, casing, liner, jointed tubing, and/or coiled tubing. Further, the tubular 120 may operate in any portion of the wellbore 114 (e.g., vertical, deviated, horizontal, and/or curved section of wellbore 114). Embodiments of DAS systems described herein can be coupled to the exterior of the tubular 120, or in some embodiments, disposed within an interior of the tubular 120. When the DAS is coupled to the exterior of the tubular 120, the DAS can be positioned within a control line, control channel, or recess in the tubular 120. In some embodiments, a sand control system can include an outer shroud to contain the tubular 120 and protect the system during installation. A control line or channel can be formed in the shroud and the DAS system can be placed in the control line or channel.

The tubular 120 extends from the surface to the producing zones and generally provides a conduit for fluids to travel from the formation 102 to the surface. A completion assembly including the tubular 120 can include a variety of other equipment or downhole tools to facilitate the production of the formation fluids from the production zones. For example, zonal isolation devices 117 are used to isolate the various zones within the wellbore 114. In this embodiment, each zonal isolation device 117 can be a packer (e.g., production packer, gravel pack packer, frac-pac packer, etc.). The zonal isolation devices 117 can be positioned between the screen assemblies 118, for example, to isolate different gravel pack zones or intervals along the wellbore 114 from each other. In general, the space between each pair of adjacent zonal isolation devices 117 defines a production interval.

The screen assemblies 118 provide sand control capability. In particular, the sand control screen elements 118, or other filter media associated with wellbore tubular 120, can be designed to allow fluids to flow therethrough but restrict and/or prevent particulate matter of sufficient size from flowing therethrough. The screen assemblies 118 can be of the type known as “wire-wrapped”, which are made up of a wire closely wrapped helically about a wellbore tubular, with a spacing between the wire wraps being chosen to allow fluid flow through the filter media while keeping particulates that are greater than a selected size from passing between the wire wraps. Other types of filter media can also be provided along the tubular 120 and can include any type of structures commonly used in gravel pack well completions, which permit the flow of fluids through the filter or screen while restricting and/or blocking the flow of particulates (e.g. other commercially-available screens, slotted or perforated liners or pipes; sintered-metal screens; sintered-sized, mesh screens; screened pipes; prepacked screens and/or liners; or combinations thereof). A protective outer shroud having a plurality of perforations therethrough may be positioned around the exterior of any such filter medium.

The gravel packs 122 are formed in the annulus 119 between the screen elements 118 (or tubular 120) and the sidewall of the wellbore 114 in an open hole completion. In general, the gravel packs 122 comprise relatively coarse granular material placed in the annulus to form a rough screen against the ingress of sand into the wellbore while also supporting the wellbore wall. The gravel pack 122 is optional and may not be present in all completions.

The fluid flowing into the tubular 120 may comprise more than one fluid component that can flow in one or more flow regimes at different points along the wellbore. Typical components include natural gas, oil, water, steam, and/or carbon dioxide. The relative proportions of these components can vary over time based on conditions within the formation 102 and the wellbore 114. Likewise, the composition of the fluid flowing into the tubular 120 sections throughout the length of the entire production string can vary significantly from section to section at any given time.

Fluid produced into the wellbore 114 as well as fluid flowing along the length of the wellbore can create acoustic sounds that can be detected using an acoustic or vibrational sensor such as a DAS system. Similarly, various solid particles present in the formation can be produced along with a fluid (e.g., oil, water, natural gas, etc.). Such solid particles are referred to herein as “sand,” and can include any solids originating within the subterranean formation regardless of size or composition. As the sand enters the wellbore 114, it may create acoustic sounds that can be detected using an acoustic sensor such as a DAS system. Each type of event such as the different fluid flows and fluid flow locations can produce an acoustic signature with unique frequency domain features. Within each type of generated signal, there can be variability in the acoustic signal, including within the spectral or frequency domain features. This variability can be used to modify or correct the event signature thresholds and/or the variability can be used as a basis for correcting the detected signals for purposes of comparison with established thresholds or signatures.

In FIG. 2, the DAS comprises an optical fiber 162 based acoustic sensing system that uses the optical backscatter component of light injected into the optical fiber for detecting acoustic perturbations (e.g., dynamic strain) along the length of the fiber 162. The light can be generated by a light generator or source 166 such as a laser, which can generate light pulses. The optical fiber 162 acts as the sensor element with no additional transducers in the optical path, and measurements can be taken along the length of the entire optical fiber 162. The measurements can then be detected by an optical receiver such as sensor 164 and selectively filtered to obtain measurements from a given depth point or range, thereby providing for a distributed measurement that has selective data for a plurality of zones along the optical fiber 162 at any given time. In this manner, the optical fiber 162 effectively functions as a distributed array of microphones spread over the entire length of the optical fiber 162, which typically spans at least the production zone 150 of the wellbore 114, to detect downhole acoustics.

The light reflected back up the optical fiber 162 as a result of the backscatter can travel back to the source, where the signal can be collected by a sensor 164 and processed (e.g., using a processor 168). In general, the time the light takes to return to the collection point is proportional to the distance traveled along the optical fiber 162. The resulting backscattered light arising along the length of the optical fiber 162 can be used to characterize the environment around the optical fiber 162. The use of a controlled light source 166 (e.g., having a controlled spectral width and frequency) may allow the backscatter to be collected and any disturbances along the length of the optical fiber 162 to be analyzed. In general, any acoustic or dynamic strain disturbances along the length of the optical fiber 162 can result in a change in the properties of the backscattered light, allowing for a distributed measurement of both the acoustic magnitude, frequency and in some cases of the relative phase of the disturbance.

An acquisition device 160 can be coupled to one end of the optical fiber 162. A physical connection can be formed between the acquisition device 160 and the optical fiber 162 such that the light source 166 can generate and insert the light into the fiber. As discussed herein, the light source 166 can generate the light (e.g., one or more light pulses), and the sensor 164 can collect and analyze the backscattered light returning up the optical fiber 162. In some contexts, the acquisition device 160 including the light source 166 and the sensor 164 can be referred to as an interrogator. The physical connection between the light source 166 and the optical fiber 162 can affect the signal strength and reflections such that each time the optical fiber 162 is connected, the detected signal from the same event can be different. For example, a variability in the detected signal can change between a first connection of the optical fiber to the light source and a second connection of the optical fiber to the light source. This variability can be accounted for using the processing techniques described herein.

In addition to the light source 166 and the sensor 164, the acquisition device 160 generally comprises a processor 168 in signal communication with the sensor 164 to perform various analysis steps described in more detail herein. While shown as being within the acquisition device 160, the processor can also be located outside of the acquisition device 160 including being located remotely from the acquisition device 160. The sensor 164 can be used to obtain data at various rates and may obtain data at a sufficient rate to detect the acoustic signals of interest with sufficient bandwidth. In some embodiment, depth resolution ranges of between about 1 meter and about 10 meters can be achieved, though longer or shorter intervals are possible. While the system 100 described herein can be used with a DAS system to acquire an acoustic signal for a location or depth range in the wellbore 114, in general, any suitable acoustic signal acquisition system can be used with the processing steps disclosed herein. For example, various microphones or other sensors can be used to provide an acoustic signal at a given location based on the acoustic signal processing described herein. The benefit of the use of the DAS system is that an acoustic signal can be obtained across a plurality of locations and/or across a continuous length of the wellbore 114 rather than at discrete locations.

Specific spectral signatures can be determined for each event by considering one or more frequency domain features. The resulting spectral signatures can then be used along with processed acoustic signal data to determine if an event is occurring at a depth range of interest. The spectral signatures can be determined by considering the different types of movement and flow occurring within a wellbore and characterizing the frequency domain features for each type of movement.

The processor 168 within the acquisition device 160 can be configured to perform various data processing to detect the presence of one or more events along the length of the wellbore 114. The acquisition device 160 can comprise a memory 170 configured to store an application or program to perform the data analysis. While shown as being contained within the acquisition device 160, the memory 170 can comprise one or more memories, any of which can be external to the acquisition device 160. In an embodiment, the processor 168 can execute the program, which can configure the processor 168 to filter the acoustic data set spatially, determine one or more frequency domain features of the acoustic signal, determine a variability in the acoustic signal, compare the resulting frequency domain feature values to the acoustic signatures, and determine whether or not an event is occurring at the selected location based on the analysis and comparison. The analysis can be repeated across various locations along the length of the wellbore 114 over a plurality of time periods to determine the occurrence of one or more events and/or event locations along the length of the wellbore 114.

When the acoustic sensor comprises a DAS system, the optical fiber 162 can return raw optical data in real time or near real time to the acquisition unit 160. The intensity of the raw optical data is proportional to the acoustic intensity of the sound being measured. In some embodiment, the raw data can be stored in the memory 170 for various subsequent uses. The sensor 164 can be configured to convert the raw optical data into an acoustic data set. Depending on the type of DAS system employed, the optical data may or may not be phase coherent and may be pre-processed to improve the signal quality (e.g., for opto-electronic noise normalization/de-trending single point-reflection noise removal through the use of median filtering techniques or even through the use of spatial moving average computations with averaging windows set to the spatial resolution of the acquisition unit, etc.). In some cases, instead of producing a signal comprising raw optical data, it is also possible for the DAS system to determine the derivative of the raw optical data to produce a derivative signal.

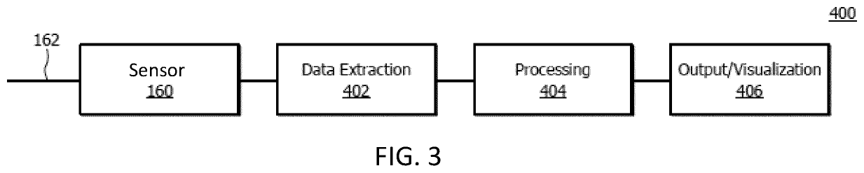

As shown schematically in FIG. 3, a system for detecting one or more events in a wellbore can comprise a data extraction unit 402, a processing unit 404, and/or an output or visualization unit 406. The data extraction unit 402 can obtain the optical data and perform the initial pre-processing steps to obtain the initial acoustic information from the signal returned from the wellbore. Various analyses can be performed including frequency band extraction, frequency analysis and/or transformation, intensity and/or energy calculations, and/or determination of one or more properties of the acoustic data. Following the data extraction unit 402, the resulting signals can be sent to a processing unit 404.

Within the processing unit, the acoustic data can be analyzed to determine a variability in the data. The resulting variability determination can be used to correct the data and/or re-determine (e.g., recalibrate) one or more event thresholds. In some embodiments, the variability analysis can be carried out prior to the pre-processing steps such that the raw data can be analyzed and processed prior to extraction of any frequency domain features. Additional steps such as normalization can also be carried out in the initial processing steps to provide for a simplified processing intensity.

Within the processing unit, the acoustic data can be analyzed, for example, by being compared to one or more acoustic signatures and/or used with one or more models (e.g., machine learning models, etc.) to determine if an event of interest is present. In some embodiments, the acoustic signatures can define thresholds or ranges of frequencies and/or frequency domain features. The analysis can then include comparing one or more thresholds or references to determine if a specific signal is present. The processing unit 404 can use the determination to determine the presence of one or more events (e.g., sand inflow, fluid inflow, fluid leaks, fluid etc.) at one or more locations based on the presence of an acoustic signal matching one or more acoustic signatures, and in some embodiments, the presence of the acoustic signal matching the one or more acoustic signatures. The resulting analysis information can then be sent from the processing unit 404 to the output/visualization unit 406 where various information such as a visualization of the location of the one or more events and/or information providing quantification information (e.g., an amount of sand inflow, a type of fluid influx, an amount of fluid leaking, and the like) can be visualized in a number of ways. In some embodiments, the resulting event information can be visualized on a well schematic, on a time log, or any other number of displays to aid in understanding where the event is occurring, and in some embodiments, to display a relative amount of the flow of a fluid and/or sand occurring at one or more locations along the length of the wellbore. While illustrated in FIG. 3 as separate units, any two or more of the units shown in FIG. 3 can be incorporated into a single unit. For example, a single unit can be present at the wellsite to provide analysis, output, and optionally, visualization of the resulting information.

A number of specific processing steps can be performed to determine the presence of an event. In some embodiments, noise detrended “acoustic variant” data can be subjected to an optional spatial filtering step following the pre-processing steps, if present. This is an optional step and helps focus primarily on an interval of interest in the wellbore. In some embodiments, the spatial filtering can narrow the focus of the analysis to a reservoir section and also allow a reduction in data, thereby simplifying the data analysis operations. The resulting data set produced through the conversion of the raw optical data can be referred to as the acoustic sample data.

This type of filtering can provide several advantages. Whether or not the acoustic data set is spatially filtered, the resulting data, for example the acoustic sample data, used for the next step of the analysis can be indicative of an acoustic sample over a defined depth (e.g., the entire length of the optical fiber, some portion thereof, or a point source in the wellbore 114). In some embodiments, the acoustic data set can comprise a plurality of acoustic samples resulting from the spatial filter to provide data over a number of depth ranges. In some embodiments, the acoustic sample may contain acoustic data over a depth range sufficient to capture multiple points of interest. In some embodiments, the acoustic sample data contains information over the entire frequency range at the depth represented by the sample. This is to say that the various filtering steps, including the spatial filtering, do not remove the frequency information from the acoustic sample data.

The processor 168 can be further configured to extract one or more frequency domain features. For example, Discrete Fourier transformations (DFT), a short time Fourier transform (STFT), wavelet analysis, or the like of the acoustic variant time domain data measured can be used at each depth section along the fiber or a section thereof to spectrally check the conformance of the acoustic sample data to one or more acoustic signatures. The spectral conformance check can be used to determine if the expected signature of an event is present in the acoustic sample data. Spectral feature extraction through time and space can be used to determine the spectral conformance and determine if an acoustic signature (e.g., a sand ingress signature, fluid inflow signature(s), hydraulic fracturing signature, etc.) is present in the acoustic sample. Within this process, various frequency domain features can be calculated for the acoustic sample data.

The use of the frequency domain features to identify one or more events has a number of advantages. First, the use of the frequency domain features results in significant data reduction relative to the raw DAS data stream. Thus, a number of frequency domain features can be calculated to allow for event identification while the remaining data can be discarded or otherwise stored, while the remaining analysis can performed using the frequency domain features. Even when the raw DAS data is stored, the remaining processing power is significantly reduced through the use of the frequency domain features rather than the raw acoustic data itself. Further, the use of the frequency domain features provides a concise, quantitative measure of the spectral character or acoustic signature of specific sounds pertinent to downhole fluid surveillance and other applications that may directly be used for real-time, application-specific signal processing.

While a number of frequency domain features can be determined for the acoustic sample data, not every frequency domain feature may be used in the characterization of each acoustic signature. Rather, subsets of the frequency domain features can be used to define the event signatures, and in some embodiments, combinations of two or more frequency domain features can be used to define the event signatures. Such frequency domain features can include, but are not limited to, the spectral centroid, the spectral spread, the spectral roll-off, the spectral skewness, the root mean square (RMS) band energy (or the normalized subband energies/band energy ratios), a loudness or total RMS energy, a spectral flux, and a spectral autocorrelation function.

The spectral centroid denotes the “brightness” of the sound captured by the optical fiber 162 and indicates the center of gravity of the frequency spectrum in the acoustic sample. The spectral centroid can be calculated as the weighted mean of the frequencies present in the signal, where the magnitudes of the frequencies present can be used as their weights in some embodiments. The value of the spectral centroid, Cᵢ, of the i^{th} frame of the acoustic signal captured at a spatial location on the fiber, may be written as:

$${C}_{i} = \frac{{\sum }_{k = 1}^{N} f ( k ) {X}_{i} ( k )}{{\sum }_{i = 1}^{N} {X}_{i} ( k )} \qquad ( Eq . 1 )$$

Where Xᵢ(k), is the magnitude of the short time Fourier transform of the i^{th} frame where ‘k’ denotes the frequency coefficient or bin index, N denotes the total number of bins and ƒ(k) denotes the centre frequency of the bin. The computed spectral centroid may be scaled to value between 0 and 1. Higher spectral centroids typically indicate the presence of higher frequency acoustics and help provide an immediate indication of the presence of high frequency noise. The calculated spectral centroid can be compared to a spectral centroid threshold or range for a given event, and when the spectral centroid meets or exceeds the threshold, the event of interest may be present.

The discussion below relating to calculating the spectral centroid is based on calculating the spectral centroid of a sample data set comprising optical data produced by the DAS system. In this case, when assessing whether a sample data set comprises a high frequency component, the calculated spectral centroid should be equal to or greater than a spectral centroid threshold. However, if, as discussed above, the sample data set comprises a derivative of the optical data, the calculated spectral centroid should be equal to or less than the spectral centroid threshold.

The absolute magnitudes of the computed spectral centroids can be scaled to read a value between zero and one. The turbulent noise generated by other sources such as fluid flow and inflow may typically be in the lower frequencies (e.g., under about 100 Hz) and the centroid computation can produce lower values, for example, around or under 0.1 post rescaling. The introduction of sand can trigger broader frequencies of sounds (e.g., a broad band response) that can extend in spectral content to higher frequencies (e.g., up to and beyond 5,000 Hz). This can produce centroids of higher values (e.g., between about 0.2 and about 0.7, or between about 0.3 and about 0.5), and the magnitude of change would remain fairly independent of the overall concentration of sanding assuming there is a good signal to noise ratio in the measurement assuming a traditional electronic noise floor (e.g., white noise with imposed flicker noise at lower frequencies). It could however, depend on the size of sand particles impinging on the pipe.

The spectral spread can also be determined for the acoustic sample. The spectral spread is a measure of the shape of the spectrum and helps measure how the spectrum is distributed around the spectral centroid. In order to compute the spectral spread, Si, one has to take the deviation of the spectrum from the computed centroid as per the following equation (all other terms defined above):

$${S}_{i} = \sqrt{\frac{{\sum }_{k = 1}^{N} {( f ( k ) - {C}_{i} )}^{2} {X}_{i} ( k )}{{\sum }_{k = 1}^{N} {X}_{i} ( k )}} \qquad ( Eq . 2 )$$

Lower values of the spectral spread correspond to signals whose spectra are tightly concentrated around the spectral centroid. Higher values represent a wider spread of the spectral magnitudes and provide an indication of the presence of a broad band spectral response. The calculated spectral spread can be compared to a spectral spread threshold or range, and when the spectral spread meets exceeds the threshold or falls within the range, the event of interest may be present. As in the case of the spectral centroid, the magnitude of spectral spread would remain fairly independent of the overall concentration of sanding for a sand ingress event assuming there is a good signal to noise ratio in the measurement. It can however, depend on the size and shape of the sand particles impinging on the pipe.

The spectral roll-off is a measure of the bandwidth of the audio signal. The Spectral roll-off of the i^{th} frame, is defined as the frequency bin ‘y’ below which the accumulated magnitudes of the short-time Fourier transform reach a certain percentage value (usually between 85%-95%) of the overall sum of magnitudes of the spectrum.

$${\sum }_{k = 1}^{y} \vert {X}_{i} ( k ) \vert = \frac{c}{100} {\sum }_{k = 1}^{N} \vert {X}_{i} ( k ) \vert \qquad ( Eq . 3 )$$

Where c=85 or 95. The result of the spectral roll-off calculation is a bin index and enables distinguishing acoustic events based on dominant energy contributions in the frequency domain. (e.g., between gas influx and fluid flow, etc.)

The spectral skewness measures the symmetry of the distribution of the spectral magnitude values around their arithmetic mean.

The RMS band energy provides a measure of the signal energy within defined frequency bins that may then be used for signal amplitude population. The selection of the bandwidths can be based on the characteristics of the captured acoustic signal. In some embodiments, a subband energy ratio representing the ratio of the upper frequency in the selected band to the lower frequency in the selected band can range between about 1.5:1 to about 3:1. In some embodiments, the subband energy ratio can range from about 2.5:1 to about 1.8:1, or alternatively be about 2:1. In some embodiment, selected frequency ranges for a signal with a 5,000 Hz Nyquist acquisition bandwidth can include: a first bin with a frequency range between 0 Hz and 20 Hz, a second bin with a frequency range between 20 Hz and 40 Hz, a third bin with a frequency range between 40 Hz and 80 Hz, a fourth bin with a frequency range between 80 Hz and 160 Hz, a fifth bin with a frequency range between 160 Hz and 320 Hz, a sixth bin with a frequency range between 320 Hz and 640 Hz, a seventh bin with a frequency range between 640 Hz and 1280 Hz, an eighth bin with a frequency range between 1280 Hz and 2500 Hz, and a ninth bin with a frequency range between 2500 Hz and 5000 Hz. While certain frequency ranges for each bin are listed herein, they are used as examples only, and other values in the same or a different number of frequency range bins can also be used. In some embodiments, the RMS band energies may also be expressed as a ratiometric measure by computing the ratio of the RMS signal energy within the defined frequency bins relative to the total RMS energy across the acquisition (Nyquist) bandwidth. This may help to reduce or remove the dependencies on the noise and any momentary variations in the broadband sound.

The total RMS energy of the acoustic waveform calculated in the time domain can indicate the loudness of the acoustic signal. In some embodiments, the total RMS energy can also be extracted from the temporal domain after filing the signal for noise.

The spectral flatness is a measure of the noisiness/tonality of an acoustic spectrum. It can be computed by the ratio of the geometric mean to the arithmetic mean of the energy spectrum value and may be used as an alternative approach to detect broadbanded signals (e.g., such as those caused by sand ingress). For tonal signals, the spectral flatness can be close to 0 and for broader band signals it can be closer to 1.

The spectral slope provides a basic approximation of the spectrum shape by a linearly regressed line. The spectral slope represents the decrease of the spectral amplitudes from low to high frequencies (e.g., a spectral tilt). The slope, the y-intersection, and the max and media regression error may be used as features.

The spectral kurtosis provides a measure of the flatness of a distribution around the mean value.

The spectral flux is a measure of instantaneous changes in the magnitude of a spectrum. It provides a measure of the frame-to-frame squared difference of the spectral magnitude vector summed across all frequencies or a selected portion of the spectrum. Signals with slowly varying (or nearly constant) spectral properties (e.g.: noise) have a low spectral flux, while signals with abrupt spectral changes have a high spectral flux. The spectral flux can allow for a direct measure of the local spectral rate of change and consequently serves as an event detection scheme that could be used to pick up the onset of acoustic events that may then be further analyzed using the feature set above to identify and uniquely classify the acoustic signal.

The spectral autocorrelation function provides a method in which the signal is shifted, and for each signal shift (lag) the correlation or the resemblance of the shifted signal with the original one is computed. This enables computation of the fundamental period by choosing the lag, for which the signal best resembles itself, for example, where the autocorrelation is maximized. This can be useful in exploratory signature analysis/even for anomaly detection for well integrity monitoring across specific depths where well barrier elements to be monitored are positioned.

Any of these frequency domain features, or any combination of these frequency domain features, can be used to provide an acoustic signature for a downhole event. In an embodiment, a selected set of characteristics can be used to provide the acoustic signature for each event, and/or all of the frequency domain features that are calculated can be used as a group in characterizing the acoustic signature for an event. The specific values for the frequency domain features that are calculated can vary depending on the specific attributes of the acoustic signal acquisition system, such that the absolute value of each frequency domain feature can change between systems. In some embodiments, the frequency domain features can be calculated for each event based on the system being used to capture the acoustic signal and/or the differences between systems can be taken into account in determining the frequency domain feature values for each signature between the systems used to determine the values and the systems used to capture the acoustic signal being evaluated.

In order to obtain the frequency domain features, the acoustic sample data can be converted to the frequency domain. In an embodiment, the raw optical data may contain or represent acoustic data in the time domain. A frequency domain representation of the data can be obtained using any suitable techniques such as a Fourier Transform, wavelet analysis, or the like. Various algorithms can be used as known in the art. In some embodiments, a Short Time Fourier Transform technique or a Discrete Time Fourier transform can be used. The resulting data sample may then be represented by a range of frequencies relative to their power levels at which they are present. The raw optical data can be transformed into the frequency domain prior to or after the application of the spatial filter and/or the variability analysis/correction. In some embodiments, the processor 168 can be configured to perform the conversion of the raw acoustic data and/or the acoustic sample data from the time domain into the frequency domain. In the process of converting the signal to the frequency domain, the power across all frequencies within the acoustic sample can be analyzed. The use of the processor 168 to perform the transformation may provide the frequency domain data in real time or near real time.

The processor 168 can then be used to analyze the acoustic sample data in the frequency domain to obtain one or more of the frequency domain features and provide an output with the determined frequency domain features for further processing. In some embodiments, the output of the frequency domain features can include features that are not used to determine the presence of every event.

The output of the processor with the frequency domain features for the acoustic sample data can then be used to determine the presence of one or more events at one or more locations in the wellbore corresponding to depth intervals over which the acoustic data is acquired or filtered. In some embodiments, the determination of the presence of one or more events can include comparing the frequency domain features with the frequency domain feature thresholds or ranges in each event signature. The frequency domain thresholds or ranges in each event signature can, in some embodiments, be modified based on the variability of the data as described in more detail herein. When the frequency domain features in the acoustic sample data match one or more of the event signatures, the event can be identified as having occurred during the sample data measurement period, which can be in real time. Various outputs can be generated to display or indicate the presence of the one or more events.

The matching of the frequency domain features to the event signatures can be accomplished in a number of ways. In some embodiments, a direct matching of the frequency domain features to the event signature thresholds or ranges can be performed across a plurality of frequency domain features. In some embodiments, machine learning or even deterministic techniques may be incorporated to allow new signals to be patterned automatically based on the descriptors. As an example, k-means clustering and k-nearest neighbor classification techniques may be used to cluster the events and classify them to their nearest neighbor to offer exploratory diagnostics/surveillance capability for various events, and in some instances, to identify new downhole events that do not have established event signatures. The use of learning algorithms may also be useful when multiple events occur simultaneously such that the acoustic signals stack to form the resulting acoustic sample data.

In addition to detecting the presence of one or more events at a depth or location in the wellbore 114, the analysis software executing on the processor 168 can be used to visualize the event locations or transfer the calculated energy values over a computer network for visualization on a remote location. In order to visualize one or more of the events, the energy or intensity of the acoustic signal can be determined at the depth interval of interest (e.g., reservoir section where the sand ingress locations are to be determined)

The intensity of the acoustic signal in the filtered data set can then be calculated, where the intensity can represent the energy or power in the acoustic data. A number of power or intensity values can be calculated. In an embodiment, the root mean square (RMS) spectral energy or sub-band energy ratios across the filtered data set frequency bandwidth can be calculated at each of the identified event depth sections over a set integration time to compute an integrated data trace of the acoustic energies over all or a portion of the length of the fiber as a function of time. This computation of an event log may be done repeatedly, such as every second, and later integrated/averaged for discrete time periods—for instance, at times of higher well drawdowns, to display a time-lapsed event log at various stages of the production process (e.g., from baseline shut-in, from during well ramp-up, from steady production, from high drawdown/production rates etc.). The time intervals may be long enough to provide suitable data, though longer times may result in larger data sets. In an embodiment, the time integration may occur over a time period between about 0.1 seconds to about 10 seconds, or between about 0.5 seconds and about a few minutes or even hours.

The resulting event log(s) computed every second can be stored in the memory 170 or transferred across a computer network, to populate an event database. The data stored/transferred in the memory 170 can include any of the frequency domain features, the filtered energy data set, and/or the RMS spectral energy through time, for one or more of the data set depths and may be stored every second. This data can be used to generate an integrated event log at each event depth sample point along the length of the optical fiber 162 along with a synchronized timestamp that indicates the times of measurement. In producing a visualization event log, the RMS spectral energy for depth sections that do not exhibit or match one or more event signatures can be set to zero. This allows those depth points or zones exhibiting or matching one or more of the event signatures to be easily identified.

As an example, the analysis software executing on the processor 168 can be used to visualize sand ingress locations or transfer the calculated energy values over a computer network for visualization on a remote location. In order to visualize the sand ingress, the energy or intensity of the acoustic signal, or at least the high frequency portion of the acoustic signal, can be determined at the depth interval of interest (e.g., reservoir section where the sand ingress locations are to be determined)

When the spectral descriptors have values above the corresponding thresholds in the event signature, the acoustic sample data can be filtered to obtain the acoustic data for the event of interest. In some embodiments, only the acoustic sample data meeting or exceeding the corresponding thresholds may be further analyzed, and the remaining acoustic sample data can have the value set to zero or can be discarded/not stored. The acoustic sample data sets meeting or exceeding the corresponding thresholds can be filtered with a high frequency filter.

The event signature can include any of those described herein such as a gas leak from a subterranean formation into an annulus in the wellbore, a gas inflow from the subterranean formation into the wellbore, sand ingress into the wellbore, a liquid inflow into the wellbore, sand transport within a tubular in the wellbore, fluid flow past a sand plug in a tubular in the wellbore, fluid flow behind a casing, a self-induced hydraulic fracture within the subterranean formation, a fluid leak past a downhole seal, or a rock fracture propagation event.

The acoustic signal can include data for all of the wellbore or only a portion of the wellbore. An acoustic sample data set can be obtained from the acoustic signal. In an embodiment, the sample data set may represent a portion of the acoustic signal for a defined depth range or point. In some embodiments, the acoustic signal can be obtained in the time domain. For example, the acoustic signal may be in the form of an acoustic amplitude relative to a collection time. The sample data set may also be in the time domain and be converted into the frequency domain using a suitable transform such as a Fourier transform. In some embodiments, the sample data set can be obtained in the frequency domain such that the acoustic signal can be converted prior to obtaining the sample data set. While the sample data set can be obtained using any of the methods described herein, the sample data set can also be obtained by receiving it from another device. For example, a separate extraction or processing step can be used to prepare one or more sample data sets and transmit them for separate processing using any of the processing methods or systems disclosed herein.

The monitoring system 110 can be used for detecting a variety of parameters and/or disturbances in the wellbore, including being used for detecting acoustic signals along the wellbore, as described above, temperatures along the wellbore, static strain and/or pressure along the wellbore, or any combination thereof.

For example, in some embodiments, the monitoring system 110 can be used to detect temperatures within the wellbore. The temperature monitoring system can include a distributed temperature sensing (DTS) system. A DTS system can rely on light injected into the optical fiber 162 along with the reflected signals to determine a temperature and/or strain based on optical time-domain reflectometry. In order to obtain DTS measurements, a pulsed laser from the light generator 166 can be coupled to the optical fiber 162 that serves as the sensing element. The injected light can be backscattered as the pulse propagates through the optical fiber 162 owing to density and composition as well as to molecular and bulk vibrations. A portion of the backscattered light can be guided back to the acquisition device 160 and split of by a directional coupler to a sensor 164. It is expected that the intensity of the backscattered light decays exponentially with time. As the speed of light within the optical fiber 162 is known, the distance that the light has passed through the optical fiber 162 can be derived using time of flight measurements.

In both distributed acoustic sensing (DAS) and DTS systems, the backscattered light includes different spectral components which contain peaks that are known as Rayleigh and Brillouin peaks and Raman bands. The Rayleigh peaks are independent of temperature and can be used to determine the DAS components of the backscattered light. The Raman spectral bands are caused by thermally influenced molecular vibrations. The Raman spectral bands can then be used to obtain information about distribution of temperature along the length of the optical fiber 162 disposed in the wellbore.

The Raman backscattered light has two components, Stokes and Anti-Stokes, one being only weakly dependent on temperature and the other being greatly influenced by temperature. The relative intensities between the Stokes and Anti-Stokes components and are a function of temperature at which the backscattering occurred. Therefore, temperature can be determined at any point along the length of the optical fiber 162 by comparing at each point the Stokes and Anti-stokes components of the light backscattered from the particular point. The Brillouin peaks may be used to monitor strain along the length of the optical fiber 162.

The DTS system can then be used to provide a temperature measurement along the length of the wellbore during the production of fluids, including fluid inflow events. The DTS system can represent a separate system from the DAS system or a single common system, which can comprise one or more acquisition devices in some embodiments. In some embodiments, a plurality of fibers 162 are present within the wellbore, and the DAS system can be coupled to a first optical fiber and the DTS system can be coupled to a second, different, optical fiber. Alternatively, a single optical fiber can be used with both systems, and a time division multiplexing or other process can be used to measure both DAS and DTS on the same optical fiber.

In an embodiment, depth resolution for the DTS system can range from about 1 meter to about 10 meters, or less than or equal to about 10, 9, 8, 7, 6, 5, 4, 3, 2, or 1 meter can be achieved. Depending on the resolution needed, larger averages or ranges can be used for computing purposes. When a high depth resolution is not needed, a system may have a wider resolution (e.g., which may be less expensive) can also be used in some embodiments. Data acquired by the DTS system 110 (e.g., via fiber 162, sensor 164, etc.) may be stored on memory 170.

While the temperature monitoring system described herein can use a DTS system to acquire the temperature measurements for a location or depth range in the wellbore 114, in general, any suitable temperature monitoring system can be used. For example, various point sensors, thermocouples, resistive temperature sensors, or other sensors can be used to provide temperature measurements at a given location based on the temperature measurement processing described herein. Further, an optical fiber comprising a plurality of point sensors such as Bragg gratings can also be used. As described herein, a benefit of the use of the DTS system is that temperature measurements can be obtained across a plurality of locations and/or across a continuous length of the wellbore 114 rather than at discrete locations.

As discussed above, the monitoring system 110 can comprise an acoustic monitoring system to monitor acoustic signals within the wellbore. The acoustic monitoring system can comprise a DAS based system, though other types of acoustic monitoring systems, including other distributed monitoring systems, can also be used.

During operation of a DAS system an optical backscatter component of light injected into the optical fiber 162 (e.g., Rayleigh backscatter) may be used to detect acoustic perturbations (e.g., dynamic strain) along the length of the fiber 162. The light backscattered up the optical fiber 162 as a result of the optical backscatter can travel back to the source, where the signal can be collected by a sensor 164 and processed (e.g., using a processor 168) as described herein. In general, any acoustic or dynamic strain disturbances along the length of the optical fiber 162 can result in a change in the properties of the backscattered light, allowing for a distributed measurement of both the acoustic magnitude (e.g., amplitude), frequency and, in some cases, of the relative phase of the disturbance. Any suitable detection methods including the use of highly coherent light beams, compensating interferometers, local oscillators, and the like can be used to produce one or more signals that can be processed to determine the acoustic signals or strain impacting the optical fiber along its length.

While the system 100 described herein can be used with a DAS system (e.g., DAS system 110) to acquire an acoustic signal for a location or depth range in the wellbore 114, in general, any suitable acoustic signal acquisition system can be used in performing embodiments of method I, II, or III (see e.g., FIG. 1A, FIG. 1D, and FIG. 1E). For example, various microphones, geophones, hydrophones, or other sensors can be used to provide an acoustic signal at a given location based on the acoustic signal processing described herein. Further, an optical fiber comprising a plurality of point sensors such as Bragg gratings can also be used. As described herein, a benefit of the use of the DAS system 110 is that an acoustic signal can be obtained across a plurality of locations and/or across a continuous length of the wellbore 114 rather than at discrete locations.

The monitoring system 110 can be used to generate temperature measurements and/or acoustic measurements along the length of the wellbore. The resulting measurements can be processed to obtain various temperature and/or acoustic based features that can then be used to identify inflow locations, identify inflowing fluid phases, and/or quantify the rate of fluid inflow.

Fluid can be produced into the wellbore 114 and into the completion assembly string. During operations, the fluid flowing into the wellbore may comprise hydrocarbon fluids, such as, for instance hydrocarbon liquids (e.g., oil), gases (e.g., natural gas such as methane, ethane, etc.), and/or water, any of which can also comprise particulates such as sand. However, the fluid flowing into the tubular may also comprise other components, such as, for instance steam, carbon dioxide, and/or various multiphase mixed flows. The fluid flow can further be time varying such as including slugging, bubbling, or time altering flow rates of different phases. The amounts or flow rates of these components can vary over time based on conditions within the formation 102 and the wellbore 114. Likewise, the composition of the fluid flowing into the tubular 120 sections throughout the length of the entire production string (e.g., including the amount of sand contained within the fluid flow) can vary significantly from section to section at any given time.

As the fluid enters the wellbore 114, the fluid can create acoustic signals and temperature changes that can be detected by the monitoring system such as the DTS system and/or the DAS systems as described herein. With respect to the temperature variations, the temperature changes can result from various fluid effects within the wellbore such as cooling based on gas entering the wellbore, temperature changes resulting from liquids entering the wellbore, and various flow related temperature changes as a result of the fluids passing through the wellbore. For example, as fluids enter the wellbore, the fluids can experience a sudden pressure drop, which can result in a change in the temperature. The magnitude of the temperature change depends on the phase and composition of the inflowing fluid, the pressure drop, and the pressure and temperature conditions. The other major thermodynamic process that takes place as the fluid enters the well is thermal mixing which results from the heat exchange between the fluid body that flows into the wellbore and the fluid that is already flowing in the wellbore. As a result, inflow of fluids from the reservoir into the wellbore can cause a deviation in the flowing well temperature profile.

By obtaining the temperature in the wellbore, a number of temperature features can be obtained from the temperature measurements. The temperature features can provide an indication of one or more temperature trends at a given location in the wellbore during a measurement period. The resulting features can form a distribution of temperature results that can then be used with various models to identify one or more events within the wellbore at the location.

The temperature measurements can represent output values from the DTS system, which can be used with or without various types of pre-processing such as noise reduction, smoothing, and the like. When background temperature measurements are used, the background measurement can represent a temperature measurement at a location within the wellbore taken in the absence of the flow of a fluid. For example, a temperature profile along the wellbore can be taken when the well is initially formed and/or the wellbore can be shut in and allowed to equilibrate to some degree before measuring the temperatures at various points in the wellbore. The resulting background temperature measurements or temperature profile can then be used in determining the temperature features in some embodiments.

In general, the temperature features represent statistical variations of the temperature measurements through time and/or depth. For example, the temperature features can represent statistical measurements or functions of the temperature within the wellbore that can be used with various models to determine whether or not fluid inflow events have occurred. The temperature features can be determined using various functions and transformations, and in some embodiments can represent a distribution of results. In some embodiments, the temperature features can represent a normal or Gaussian distribution. In some embodiments, the temperature measurements can represent measurement through time and depth, such as variations taken first with respect to time and then with respect to depth or first with respect to depth and then with respect to time. The resulting distributions can then be used with models such as multivariate models to determine the presence of the fluid inflow events.

In some embodiments, the temperature features can include various features including, but not limited to, a depth derivative of temperature with respect to depth, a temperature excursion measurement, a baseline temperature excursion, a peak-to-peak value, a Fast Fourier transform (FFT), a Laplace transform, a wavelet transform, a derivative of temperature with respect to depth, a heat loss parameter, an autocorrelation, and combinations thereof.

In some embodiments, the temperature features can comprise a depth derivative of temperature with respect to depth. This feature can be determined by taking the temperature measurements along the wellbore and smoothing the measurements. Smoothing can comprise a variety of steps including filtering the results, de-noising the results, or the like. In some embodiments, the temperature measurements can be median filtered within a given window to smooth the measurements. Once smoothed, the change in the temperature with depth can be determined. In some embodiments, this can include taking a derivative of the temperature measurements with respect to depth along the longitudinal axis of the wellbore 114. The depth derivative of temperature values can then be processed, and the measurement with a zero value (e.g., representing a point of no change in temperature with depth) that have preceding and proceeding values that are non-zero and have opposite signs in depth (e.g., zero below which the value is negative and above positive or vice versa) can have the values assign to the nearest value. This can then result in a set of measurements representing the depth derivative of temperature with respect to depth.

In some embodiments, the temperature features can comprise a temperature excursion measurement. The temperature excursion measurement can comprise a difference between a temperature reading at a first depth and a smoothed temperature reading over a depth range, where the first depth is within the depth range. In some embodiments, the temperature excursion measurement can represent a difference between de-trended temperature measurements over an interval and the actual temperature measurements within the interval. For example, a depth range can be selected within the wellbore 114. The temperature readings within a time window can be obtained within the depth range and de-trended or smoothed. In some embodiments, the de-trending or smoothing can include any of those processes described above, such as using median filtering of the data within a window within the depth range. For median filtering, the larger the window of values used, the greater the smoothing effect can be on the measurements. For the temperature excursion measurement, a range of windows from about 10 to about 100 values, or between about 20-60 values (e.g., measurements of temperature within the depth range) can be used to median filter the temperature measurements. A difference can then be taken between the temperature measurement at a location and the de-trended (e.g., median filtered) temperature values. The temperature measurements at a location can be within the depth range and the values being used for the median filtering. This temperature feature then represents a temperature excursion at a location along the wellbore 114 from a smoothed temperature measurement over a larger range of depths around the location in the wellbore 114.

In some embodiments, the temperature features can comprise a baseline temperature excursion. The baseline temperature excursion represents a difference between a de-trended baseline temperature profile and the current temperature at a given depth. In some embodiments, the baseline temperature excursion can rely on a baseline temperature profile that can contain or define the baseline temperatures along the length of the wellbore 114. As described herein, the baseline temperatures represent the temperature as measured when the wellbore 114 is shut in. This can represent a temperature profile of the formation in the absence of fluid flow. While the wellbore 114 may affect the baseline temperature readings, the baseline temperature profile can approximate a formation temperature profile. The baseline temperature profile can be determined when the wellbore 114 is shut in and/or during formation of the wellbore 114, and the resulting baseline temperature profile can be used over time. If the condition of the wellbore 114 changes over time, the wellbore 114 can be shut in and a new baseline temperature profile can be measured or determined. It is not expected that the baseline temperature profile is re-determined at specific intervals, and rather it would be determined at discrete times in the life of the wellbore 114. In some embodiments, the baseline temperature profile can be re-determined and used to determine one or more temperature features such as the baseline temperature excursion.

Once the baseline temperature profile is obtained, the baseline temperature measurements at a location in the wellbore 114 can be subtracted from the temperature measurement detected by the temperature monitoring system 110 at that location to provide baseline subtracted values. The results can then be obtained and smoothed or de-trended. For example, the resulting baseline subtracted values can be median filtered within a window to smooth the data. In some embodiments, a window between 10 and 500 temperature values, between 50 and 400 temperature values, or between 100 and 300 temperature values can be used to median filter the resulting baseline subtracted values. The resulting smoothed baseline subtracted values can then be processed to determine a change in the smoothed baseline subtracted values with depth. In some embodiments, this can include taking a derivative of the smoothed baseline subtracted values with respect to depth along the longitudinal axis of the wellbore. The resulting values can represent the baseline temperature excursion feature.

In some embodiments, the temperature features can comprise a peak-to-peak temperature value. This feature can represent the difference between the maximum and minimum values (e.g., the range, etc.) within the temperature profile along the wellbore 114. In some embodiments, the peak-to-peak temperature values can be determined by detecting the maximum temperature readings (e.g., the peaks) and the minimum temperature values (e.g., the dips) within the temperature profile along the wellbore 114. The difference can then be determined within the temperature profile to determine peak-to-peak values along the length of the wellbore 114. The resulting peak-to-peak values can then be processed to determine a change in the peak-to-peak values with respect to depth. In some embodiments, this can include taking a derivative of the peak-to-peak values with respect to depth along the longitudinal axis of the wellbore 114. The resulting values can represent the peak-to-peak temperature values.

Other temperature features can also be determined from the temperature measurements. In some embodiments, various statistical measurements can be obtained from the temperature measurements along the wellbore 114 to determine one or more temperature features. For example, a cross-correlation of the temperature measurements with respect to time can be used to determine a cross-correlated temperature feature. The temperature measurements can be smoothed as described herein prior to determining the cross-correlation with respect to time. As another example, an autocorrelation measurement of the temperature measurements can be obtained with respect to depth. Autocorrelation is defined as the cross-correlation of a signal with itself. An autocorrelation temperature feature can thus measure the similarity of the signal with itself as a function of the displacement. An autocorrelation temperature feature can be used, in applications, as a means of anomaly detection for event (e.g., fluid inflow) detection. The temperature measurements can be smoothed and/or the resulting autocorrelation measurements can be smoothed as described herein to determine the autocorrelation temperature features.

In some embodiments, the temperature features can comprise a Fast Fourier transform (FFT) of the distributed temperature sensing (e.g., DTS) signal. This algorithm can transform the distributed temperature sensing signal from the time domain into the frequency domain, thus allowing detection of the deviation in DTS along length (e.g., depth). This temperature feature can be utilized, for example, for anomaly detection for event (e.g., fluid inflow) detection purposes.

In some embodiments, the temperature features can comprise the Laplace transform of DTS. This algorithm can transform the DTS signal from the time domain into Laplace domain allows us to detect the deviation in the DTS along length (e.g., depth of wellbore 114). This temperature feature can be utilized, for example, for anomaly detection for event (e.g., fluid inflow) detection. This feature can be utilized, for example, in addition to (e.g., in combination with) the FFT temperature feature.

In some embodiments, the temperature features can comprise a wavelet transform of the distributed temperature sensing (e.g., DTS) signal and/or of the derivative of DTS with respect to depth, dT/dz. The wavelet transform can be used to represent the abrupt changes in the signal data. This feature can be utilized, for example, in inflow detection. A wavelet is described as an oscillation that has zero mean, which can thus make the derivative of DTS in depth more suitable for this application. In embodiments and without limitation, the wavelet can comprise a Morse wavelet, an Analytical wavelet, a Bump wavelet, or a combination thereof.

In some embodiments, the temperature features can comprise a derivative of DTS with respect to depth, or dT/dz. The relationship between the derivative of flowing temperature T_{ƒ} with respect to depth (L) (e.g., dT_{ƒ}/dL) has been described by several models. For example, and without limitation, the model described by Sagar (Sagar, R., Doty, D. R., & Schmidt, Z. (1991, November 1). Predicting Temperature Profiles in a Flowing Well. Society of Petroleum Engineers. doi:10.2118/19702-PA) which accounts for radial heat loss due to conduction and describes a relationship (Equation (1) below) between temperature change in depth and mass rate. The mass rate wₜ is conversely proportional to the relaxation parameter A and, as the relaxation parameter A increases, the change in temperature in depth increases. Hence this temperature feature can be designed to be used, for example, in events comprising inflow quantification.

The formula for the relaxation parameter, A, is provided in Equation (2):

$$\begin{matrix}\frac{{dT}_{f}}{dL} = - A [ ( {T}_{f} - {T}_{e} ) + \frac{g}{{g}_{c}} \frac{sin θ}{{JC}_{pm} A} - \frac{{F}_{c}}{A} ] . & ( 1 ) \\ A = ( \frac{2 π}{{w}_{l} {C}_{pl}} ) ( \frac{{r}_{ti} {Uk}_{e}}{{k}_{e} + {r}_{ti} Uf / 12} ) ( \frac{1}{86 , 400 \times 12} ) & ( 2 )\end{matrix}$$

A coefficient, ft⁻¹
C_{pL}=specific heat of Liquid, Btu/lbm-° F.
Cₚₘ=specific heat of mixture. Btu/lbm-° F.
Cₚₒ=specific heat of oil, Btu/lbm-° F.
C_{pw}=specific heat of water, Btu/lbm-° F.
d_{c}=casing diameter, in.
dₜ=tubing diameter, in,
d_{wb}=wellbore diameter, in.
D=depth, ft
Dᵢₙⱼ=injection depth, ft
ƒ=modified dimensionless heat conduction time function for long times for earth
ƒ(t)=dimensionless transient heat conduction time function for earth
F_{c}=correction factor
F̅_{c}=average correction factor for one length interval
g=acceleration of gravity, 32.2 ft/sec²
g_{c}=conversion factor, 32.2 ft-lbm/sec²-lbf
g_{G}=geothermal gradient, ° F./ft
h=specific enthalpy, Btu/lbm
J=mechanical equivalent of heat, 778 ft-lbf/Btu
kₐₙ=thermal conductivity of material in annulus, Btu/D-ft-° F.
k_{ang}=thermal conductivity of gas in annulus, Btu/D-ft-° F. k_{anw}=thermal conductivity of water in annulus, Btu/D-ft-° F.
k_{cem}=thermal conductivity of cement, Btu/D-ft-° F.
kₑ=thermal conductivity of earth, Btu/D-ft-° F.
L=length of well from perforations, ft
Lᵢₙ=length from perforation to inlet, ft
p=pressure, psi
p_{wh}=wellhead pressure, psig
q_{gf}=formation gas flow rate, scf/D
q_{ginj}=injection gas flow rate, scf/D
qₒ=oil flow rate, STB/D
q_{w}=water flow rate, STB/BD
Q=heat transfer between fluid and surrounding area, Btu/lhm
r_{ci}=inside casing radius, in.
r_{co}=outside casing radius, in.
rₜᵢ=inside tubing radius, in.
rₜₒ>=outside tubing radius, in.
r_{wb}=wellbore radius, in.
R_{gL}=gas/liquid ratio, scf/STB
T=temperature, ° F.
T_{bh}=bottomhole temperature, ° F.
T_{c}=casing temperature, ° F.
Tₑ=surrounding earth temperature, ° F.
Tₑᵢₙ=earth temperature at inlet, ° F.
T_{ƒ}=flowing fluid temperature, ° F.
T_{ƒin}=flowing fluid temperature at inlet, ° F.
Tₕ=cement/earth interface temperature, ° F.
U=overall heat transfer coefficient, Btu/D-ft-° F.
v=fluid velocity, ft/sec
V=volume
wₜ=total mass flow rate, lbm/sec
Z=height from bottom of hole, ft
Zᵢₙ=height from bottom of hole at inlet, ft
α=thermal diffusivity of earth, 0.04 ft²/hr
γ_{API}=oil gravity, ° API
γ_{g}=gas specific gravity (air=1)
γₒ=oil specific gravity
γ_{w}=water specific gravity
θ=angle of inclination, degrees
μ=Joule-Thomson coefficient

In some embodiments, the temperature features can comprise a heat loss parameter. As described hereinabove, Sagar's model describes the relationship between various input parameters, including the mass rate wₜ and temperature change in depth dT_{f}/dL. These parameters can be utilized as temperature features in a machine learning model which uses features from known cases (production logging results) as learning data sets, when available. These features can include geothermal temperature, deviation, dimensions of the tubulars 120 that are in the well (casing 112, tubing 120, gravel pack 122 components, etc.), as well as the wellbore 114, well head pressure, individual separator rates, downhole pressure, gas/liquid ratio, and/or a combination thereof. Such heat loss parameters can, for example, be utilized as inputs in a machine learning model for events comprising inflow quantification of the mass flow rate wₜ.

In some embodiments, the temperature features can comprise a time-depth derivative and/or a depth-time derivative. A temperature feature comprising a time-depth derivative can comprise a change in a temperature measurement at one or more locations across the wellbore taken first with respect to time, and a change in the resulting values with respect to depth can then be determined. Similarly, a temperature feature comprising a depth-time derivative can comprise a change in a temperature measurement at one or more locations across the wellbore taken first with respect to depth, and a change in the resulting values with respect to time can then be determined.

In some embodiments, the temperature features can be based on dynamic temperature measurements rather than steady state or flowing temperature measurements. In order to obtain dynamic temperature measurements, a change in the operation of the system (e.g., wellbore) can be introduced, and the temperature monitored using the temperature monitoring system. For example in a wellbore environment, the change in conditions can be introduced by shutting in the wellbore, opening one or more sections of the wellbore to flow, introducing a fluid to the wellbore (e.g., injecting a fluid), and the like. When the wellbore is shut in from a flowing state, the temperature profile along the wellbore may be expected to change from the flowing profile to the baseline profile over time. Similarly, when a wellbore that is shut in is opened for flow, the temperature profile may change from a baseline profile to a flowing profile. Based on the change in the condition of the wellbore, the temperature measurements can change dynamically over time. In some embodiments, this approach can allow for a contrast in thermal conductivity to be determined between a location or interval having radial flow (e.g., into or out of the wellbore) to a location or interval without radial flow. One or more temperature features can then be determined using the dynamic temperature measurements. Once the temperature features are determined from the temperature measurements obtained from the temperature monitoring system, one or more of the temperature features can be used to identify events along the length being monitored (e.g., within the wellbore), as described in more detail herein.

Although described herein as systems and methods for reducing data storage volumes in wellbore event detection, the herein disclosed systems and methods can also be utilized for reducing data storage volumes for a plethora of other event detections, such as, without limitation, security events, transportation events, geothermal events, carbon capture and CO₂ injection events, facility monitoring events, pipeline monitoring events, dam monitoring events, and etc.

Any of the systems and methods disclosed herein can be carried out on a computer or other device comprising a processor, such as the acquisition device 160 of FIG. 2. FIG. 4 illustrates a computer system 780 suitable for implementing one or more embodiments disclosed herein such as the acquisition device or any portion thereof. The computer system 780 includes a processor 781 (which may be referred to as a central processor unit or CPU) that is in communication with memory devices including secondary storage 782, read only memory (ROM) 783, random access memory (RAM) 784, input/output (I/O) devices 785, and network connectivity devices 786. The processor 781 may be implemented as one or more CPU chips.

It is understood that by programming and/or loading executable instructions onto the computer system 780, at least one of the CPU 781, the RAM 784, and the ROM 783 are changed, transforming the computer system 780 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 780 is turned on or booted, the CPU 781 may execute a computer program or application. For example, the CPU 781 may execute software or firmware stored in the ROM 783 or stored in the RAM 784. In some cases, on boot and/or when the application is initiated, the CPU 781 may copy the application or portions of the application from the secondary storage 782 to the RAM 784 or to memory space within the CPU 781 itself, and the CPU 781 may then execute instructions of which the application is comprised. In some cases, the CPU 781 may copy the application or portions of the application from memory accessed via the network connectivity devices 786 or via the I/O devices 785 to the RAM 784 or to memory space within the CPU 781, and the CPU 781 may then execute instructions of which the application is comprised. During execution, an application may load instructions into the CPU 781, for example load some of the instructions of the application into a cache of the CPU 781. In some contexts, an application that is executed may be said to configure the CPU 781 to do something, e.g., to configure the CPU 781 to perform the function or functions promoted by the subject application. When the CPU 781 is configured in this way by the application, the CPU 781 becomes a specific purpose computer or a specific purpose machine.

The secondary storage 782 is typically comprised of one or more disk drives or tape drives and is used for non-volatile storage of data and as an over-flow data storage device if RAM 784 is not large enough to hold all working data. Secondary storage 782 may be used to store programs which are loaded into RAM 784 when such programs are selected for execution. The ROM 783 is used to store instructions and perhaps data which are read during program execution. ROM 783 is a non-volatile memory device which typically has a small memory capacity relative to the larger memory capacity of secondary storage 782. The RAM 784 is used to store volatile data and perhaps to store instructions. Access to both ROM 783 and RAM 784 is typically faster than to secondary storage 782. The secondary storage 782, the RAM 784, and/or the ROM 783 may be referred to in some contexts as computer readable storage media and/or non-transitory computer readable media.

I/O devices 785 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 786 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 786 may enable the processor 781 to communicate with the Internet or one or more intranets. With such a network connection, it is contemplated that the processor 781 might receive information from the network, or might output information to the network (e.g., to an event database) in the course of performing the above-described method steps. Such information, which is often represented as a sequence of instructions to be executed using processor 781, may be received from and outputted to the network, for example, in the form of a computer data signal embodied in a carrier wave.

Such information, which may include data or instructions to be executed using processor 781 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 781 executes instructions, codes, computer programs, scripts which it accesses from hard disk, floppy disk, optical disk (these various disk based systems may all be considered secondary storage 782), flash drive, ROM 783, RAM 784, or the network connectivity devices 786. While only one processor 781 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 782, for example, hard drives, floppy disks, optical disks, and/or other device, the ROM 783, and/or the RAM 784 may be referred to in some contexts as non-transitory instructions and/or non-transitory information.

In an embodiment, the computer system 780 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 780 to provide the functionality of a number of servers that is not directly bound to the number of computers in the computer system 780. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 780, at least portions of the contents of the computer program product to the secondary storage 782, to the ROM 783, to the RAM 784, and/or to other non-volatile memory and volatile memory of the computer system 780. The processor 781 may process the executable instructions and/or data structures in part by directly accessing the computer program product, for example by reading from a CD-ROM disk inserted into a disk drive peripheral of the computer system 780. Alternatively, the processor 781 may process the executable instructions and/or data structures by remotely accessing the computer program product, for example by downloading the executable instructions and/or data structures from a remote server through the network connectivity devices 786. The computer program product may comprise instructions that promote the loading and/or copying of data, data structures, files, and/or executable instructions to the secondary storage 782, to the ROM 783, to the RAM 784, and/or to other non-volatile memory and volatile memory of the computer system 780.

In some contexts, the secondary storage 782, the ROM 783, and the RAM 784 may be referred to as a non-transitory computer readable medium or a computer readable storage media. A dynamic RAM embodiment of the RAM 784, likewise, may be referred to as a non-transitory computer readable medium in that while the dynamic RAM receives electrical power and is operated in accordance with its design, for example during a period of time during which the computer system 780 is turned on and operational, the dynamic RAM stores information that is written to it. Similarly, the processor 781 may comprise an internal RAM, an internal ROM, a cache memory, and/or other internal non-transitory storage blocks, sections, or components that may be referred to in some contexts as non-transitory computer readable media or computer readable storage media.

Having described various systems and methods herein, specific embodiments can include, but are not limited to:
In a first embodiment, a method of reducing data storage volumes for event detection, the method comprises: identifying an anomaly in a first portion of a sensor data set using one or more features derived from the sensor data, wherein the sensor data set is obtained from a sensor, and wherein the sensor data set comprises a plurality of individual sensor readings through time; determining one or more signal characteristics of the first portion of the sensor data set; and storing, in a memory, the one or more signal characteristics of the first portion of the sensor data set, wherein a second portion of the sensor data does not contain the anomaly, and wherein the second portion of the sensor data is not stored in the memory.

A second embodiment can include the method of the first embodiment, wherein the one or more signal characteristics comprise at least one of: a time, a locator, or an identifier associated with the first portion of the sensor data.

A third embodiment can include the method of any one of the first or second embodiments, wherein the one or more signal characteristics comprise one or more features derived from the first portion of the sensor data set, a time, a locator, or an amplitude of the first portion of the sensor data set.

A fourth embodiment can include the method of any one of the first to third embodiments, further comprising: obtaining sensor data from the sensor; denoising the sensor data to provide a denoised sensor data; thresholding the denoised sensor data to provide the sensor data set, wherein thresholding the denoised sensor data replaces a sensor data set value below a threshold with a zero value.

A fifth embodiment can include the method of any one of the first to fourth embodiments, wherein denoising the sensor data comprises median filtering the sensor data.

A sixth embodiment can include the method of any one of the first to fifth embodiments, wherein identifying the anomaly in the first portion of a sensor data set using the one or more features derived from the sensor data comprises: identifying the anomaly in the sensor data set at a first time; comparing, at a second time, the one or more features at the second time with the one or more features at the first time; determining that the one or more feature at the second time are within a threshold difference of the one or more features at the first time; and determining the presence of the anomaly in the sensor data set at the second time based on the one or more feature at the second time being within the threshold difference of the one or more features at the first time.

A seventh embodiment can include the method of any one of the first to sixth embodiments, wherein storing the one or more signal characteristics of the first portion of the sensor data set comprises: storing the one or more signal characteristics at a first time; determining a difference between the one or more signal characteristic at the first time and the one or more signal characteristics at a second time; and storing the difference for the one or more signal characteristics for the second time.

An eighth embodiment can include the method of the seventh embodiment, wherein the one or more signal characteristics are stored at the first time for a first location, wherein the method further comprises: determining a difference between the one or more signal characteristics at the first time and at the first location and the one or more signal characteristics at the first time and at a second location; and storing the difference for the one or more signal characteristics for the first time at the second location.

A ninth embodiment can include the method of any one of the first to eighth embodiments, wherein the sensor data set comprises an acoustic data set, a temperature data set, a pressure data set, a strain data set, or a flow data set.

A tenth embodiment can include the method of any one of the first to ninth embodiments, further comprising: populating a second sensor data set with the stored one or more signal characteristics of the first portion of the sensor data set from the memory; populating the second sensor data set with zero values for the second portion of the sensor data set, wherein the second sensor data set is representative of the anomalies within the sensor data set.

An eleventh embodiment can include the method of the tenth embodiment, further comprising: presenting, on an output device, the second sensor data set as a representation of the sensor data set.

A twelfth embodiment can include the method of the eleventh embodiment, further comprising: generating one or more averaged data sets, wherein the averaged data sets average two or more readings from the second sensor data; and presenting, on the output device, at least one of the one or more averaged data sets.

In a thirteenth embodiment, a system for reducing data storage volumes for event detection, the system comprises: a memory; a data reduction program stored in the memory; and a processor, wherein the data reduction program, when executed on the processor, configures the processor to: identifying an anomaly in a first portion of a sensor data set using one or more features derived from the sensor data, wherein the sensor data set is obtained from a sensor, and wherein the sensor data set comprises a plurality of individual sensor readings through time; determine one or more signal characteristics of the first portion of the sensor data set; and store, in a memory, the one or more signal characteristics of the first portion of the sensor data set, wherein a second portion of the sensor data does not contain the anomaly, and wherein the second portion of the sensor data is not stored in the memory.

A fourteenth embodiment can include the system of the thirteenth embodiment, wherein the one or more signal characteristics comprise at least one of: a time, a locator, or an identifier associated with the first portion of the sensor data.

A fifteenth embodiment can include the system of the fourteenth embodiment, wherein the one or more signal characteristics comprise one or more features derived from the first portion of the sensor data set, a time, a locator, or an amplitude of the first portion of the sensor data set.

A sixteenth embodiment can include the system of any one of the fourteenth or fifteenth embodiments, wherein the processor is further configured to: receive sensor data from the sensor; denoise the sensor data to provide a denoised sensor data; and threshold the denoised sensor data to provide the sensor data set, wherein thresholding the denoised sensor data replaces a sensor data set value below a threshold with a zero value.

A seventeenth embodiment can include the system of the sixteenth embodiment, wherein the processor is configured to denoise the sensor data by median filtering the sensor data.

An eighteenth embodiment can include the system of any one of the thirteenth to seventh embodiments, wherein the processor is configured for identifying the anomaly in the first portion of a sensor data set using the one or more features derived from the sensor data by: identifying the anomaly in the sensor data set at a first time; comparing, at a second time, the one or more features at the second time with the one or more features at the first time; determining that the one or more feature at the second time are within a threshold difference of the one or more features at the first time; and determining the presence of the anomaly in the sensor data set at the second time based on the one or more feature at the second time being within the threshold difference of the one or more features at the first time.

A nineteenth embodiment can include the system of any one of the thirteenth to eighteenth embodiments, wherein storing the one or more signal characteristics of the first portion of the sensor data set comprises: storing the one or more signal characteristics at a first time; determining a difference between the one or more signal characteristic at the first time and the one or more signal characteristics at a second time; and storing the difference for the one or more signal characteristics for the second time.

A twentieth embodiment can include the system of the nineteenth embodiment, wherein the one or more signal characteristics are stored at the first time for a first location, wherein the processor is further configured to: determine a difference between the one or more signal characteristics at the first time and at the first location and the one or more signal characteristics at the first time and at a second location; and store the difference for the one or more signal characteristics for the first time at the second location.

A twenty first embodiment can include the system of any one of the thirteenth to twenty first embodiments, wherein the sensor data set comprises an acoustic data set, a temperature data set, a pressure data set, a strain data set, or a flow data set.

A twenty second embodiment can include the system of any one of the thirteenth to twenty first embodiments, wherein the processor is further configured to: populate a second sensor data set with the stored one or more signal characteristics of the first portion of the sensor data set from the memory; and populate the second sensor data set with zero values for the second portion of the sensor data set, wherein the second sensor data set is representative of the anomalies within the sensor data set.

A twenty third embodiment can include the system of the twenty second embodiment, further comprising: an output device, configured for presenting the second sensor data set as a representation of the sensor data set.

A twenty fourth embodiment can include the system of the twenty third embodiment, wherein the processor is further configured to: generate one or more averaged data sets, wherein the averaged data sets average two or more readings from the second sensor data; and present, on the output device, at least one of the one or more averaged data sets.

In a twenty fifth embodiment, a method of reducing data storage volumes for event detection, the method comprises: obtaining sensor data, wherein the sensor data is obtained from one or more sensors, and wherein the sensor data comprises measured sensor values through time and location; determining one or more signal characteristics of the sensor data, wherein the one or more signal characteristics comprise one or more features derived from the sensor data; storing the sensor data and the one or more signal characteristics of the sensor data at a first time; determining a difference value between the sensor data and the one or more signal characteristics at the first time and the sensor data and the one or more signal characteristics at a second time; and storing the difference value for the sensor data and the one or more signal characteristics for the second time.

A twenty sixth embodiment can include the method of the twenty fifth embodiment, wherein the sensor data and the one or more signal characteristics are stored at the first time for a first location, wherein the method further comprises: determining a difference value between the sensor data and the one or more signal characteristics at the first time and at the first location and the sensor data and the one or more signal characteristics at the first time and at a second location; and storing the difference value for the sensor data and the one or more signal characteristics for the first time at the second location.

A twenty seventh embodiment can include the method of any one of the twenty fifth or twenty sixth embodiments, further comprising: rounding the difference value for the sensor data and the one or more signal characteristics; and storing the rounded difference value for the sensor data and the one or more signal characteristics.

A twenty eighth embodiment can include the method of any one of the twenty fifth to twenty seventh embodiments, further comprising: identifying an anomaly in a first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, and wherein a second portion of the sensor data does not contain the anomaly, and wherein the second portion of the sensor data is not stored in the memory.

A twenty ninth embodiment can include the method of any one of the twenty fifth to twenty seventh embodiments, further comprising: identifying an anomaly in a first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, and wherein a second portion of the sensor data does not contain the anomaly, and wherein only zero values are stored for the second portion of the sensor data.

A thirtieth embodiment can include the method of the twenty ninth embodiment further comprising: identifying zero values within the stored data; and removing the zero values from the stored data.

A thirty first embodiment can include the method of any one of the twenty eighth to thirtieth embodiments, further comprising: populating a sensor data set with the stored one or more signal characteristics of the first portion of the sensor data from the memory; populating the sensor data set with zero values for the second portion of the sensor data, wherein the sensor data set is representative of the anomalies within the sensor data.

A thirty second embodiment can include the method of the thirty first embodiment further comprising: presenting, on an output device, the sensor data set as a representation of the sensor data.

A thirty third embodiment can include the method of the thirty second embodiment, further comprising: generating one or more averaged data sets, wherein the averaged data sets average two or more readings from the sensor data set; and presenting, on the output device, at least one of the one or more averaged data sets.

In a thirty fourth embodiment, a system of reducing data storage volumes for event detection, the system comprises: a memory; a data reduction program stored in the memory; and a processor, wherein the data reduction program, when executed on the processor, configures the processor to: receive sensor data, wherein the sensor data is obtained from one or more sensors, and wherein the sensor data comprises measured sensor values through time and location; determine one or more signal characteristics of the sensor data, wherein the one or more signal characteristics comprise one or more features derived from the sensor data; store the sensor data and the one or more signal characteristics of the sensor data at a first time; determine a difference value between the sensor data and the one or more signal characteristics at the first time and the sensor data and the one or more signal characteristics at a second time; and store the difference value for the sensor data and the one or more signal characteristics for the second time.

A thirty fifth embodiment can include the system of the thirty fourth embodiment, wherein the sensor data and the one or more signal characteristics are stored at the first time for a first location, wherein the processor is further configured to: determine a difference value between the sensor data and the one or more signal characteristics at the first time and at the first location and the sensor data and the one or more signal characteristics at the first time and at a second location; and store the difference value for the sensor data and the one or more signal characteristics for the first time at the second location.

A thirty sixth embodiment can include the system of any one of the thirty fourth to thirty fifth embodiments, wherein the processor is further configured to: round the difference value for the sensor data and the one or more signal characteristics; and store the rounded difference value for the sensor data and the one or more signal characteristics.

A thirty seventh embodiment can include the system of any one of the thirty fourth to thirty sixth embodiments, wherein the processor is further configured to: identify an anomaly in a first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, and wherein a second portion of the sensor data does not contain the anomaly, and wherein the processor is further configured not to store the second portion of the sensor data in the memory.

A thirty eighth embodiment can include the system of any one of the thirty fourth to thirty sixth embodiments, wherein the processor is further configured to: identify an anomaly in a first portion of the sensor data using one or more features derived from the sensor data, wherein the sensor data and the one or more signal characteristics of the sensor data at the first time and the difference value for the sensor data and the one or more signal characteristics for the second time are within the first portion of the sensor data, and wherein a second portion of the sensor data does not contain the anomaly, and wherein the processor is configured to store in the memory only zero values for the second portion of the sensor data.

A thirty ninth embodiment can include the system of the thirty eighth embodiment, wherein the processor is further configured to: identify zero values within the stored data; and remove the zero values from the stored data.

A fortieth embodiment can include the system of any one of the thirty seventh to thirty ninth embodiments, wherein the processor is further configured to: populate a sensor data set with the stored one or more signal characteristics of the first portion of the sensor data from the memory; populate the sensor data set with zero values for the second portion of the sensor data, wherein the sensor data set is representative of the anomalies within the sensor data.

A forty first embodiment can include the system of the fortieth embodiment, further comprising an output device, wherein the processor is further configured to: present, on the output device, the sensor data set as a representation of the sensor data.

A forty second embodiment can include the system of the forty first embodiment, wherein the processor is further configured to: generate one or more averaged data sets, wherein the averaged data sets average two or more readings from the sensor data set; and present, on the output device, at least one of the one or more averaged data sets.

In a forty third embodiment, a method of reducing data storage volumes for event detection in wellbores comprises: obtaining acoustic data within a wellbore, wherein the acoustic data comprises sensor readings for a plurality of depths along the wellbore and for a plurality of time periods; identifying an anomaly in a first portion of a sensor data set using one or more frequency domain features derived from the sensor data; storing, in a memory, the acoustic data and the one or more frequency domain features for a first time for the first portion of the sensor data set; determining a difference value for the acoustic data and the one or more frequency domain features between the first time and a second time; and storing, in the memory, the difference value for the second time.

A forty fourth embodiment can include the method of the forty third embodiment, wherein the acoustic data and the one or more frequency domain features are stored for the first time and a first depth for the first portion of the sensor data set, and wherein the method further comprises: determining a depth difference value for the acoustic data and the one or more frequency domain features between: 1) the first time and the first depth, and 2) the first time and a second depth, wherein storing the acoustic data and the one or more frequency domain features comprises storing the depth difference value for the first time and the second depth.

A forty fifth embodiment can include the method of any one of the forty third to forty fourth embodiments, further comprising: denoising the acoustic data to provide a denoised acoustic data prior to identifying the anomaly.

A forty sixth embodiment can include the method of the forty fifth embodiment, wherein denoising comprises median filtering the acoustic data.

A forty seventh embodiment can include the method of the forty fifth embodiment further comprising thresholding the denoised acoustic data, wherein thresholding the denoised acoustic data replaces sensor data values below a threshold with a zero value.

A forty eighth embodiment can include the method of any one of the forty third to forty seventh embodiments, where identifying the anomaly in the first portion of the data set using the one or more frequency domain features derived from the sensor data comprises: identifying the anomaly in the sensor data set at a first time; comparing, at a second time, the one or more features at the second time with the one or more features at the first time; determining that the one or more feature at the second time are within a threshold difference of the one or more features at the first time; and determining the presence of the anomaly in the sensor data set at the second time based on the one or more feature at the second time being within the threshold difference of the one or more features at the first time.

A forty ninth embodiment can include the method of any one of the forty third to forty eighth embodiments, further comprising: populating a second sensor data set with the stored frequency domain features of the first portion of the sensor data set from the memory; populating the second sensor data set with zero values for the second portion of the sensor data set, wherein the second sensor data set is representative of the anomalies within the sensor data set.

A fiftieth embodiment can include the method of the forty ninth embodiment, further comprising: presenting, on an output device, the second sensor data set as a representation of the sensor data set.

A fifty first embodiment can include the method of the fiftieth embodiment, further comprising: generating one or more averaged data sets, wherein the averaged data sets average two or more readings from the second sensor data; and presenting, on the output device, at least one of the one or more averaged data sets.

A fifty second embodiment can include the method of any one of the forty third to fifty first embodiments, wherein the one or more frequency domain features comprise at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof.

In a fifty third embodiment, a system for reducing data storage volumes for event detection in wellbores comprises: a memory; a data reduction program stored in the memory; and a processor, wherein the data reduction program, when executed on the processor, configures the processor to: receive acoustic data within the wellbore, wherein the acoustic data comprises sensor readings for a plurality of depths along the wellbore and for a plurality of time periods; identify an anomaly in a first portion of a sensor data set using one or more frequency domain features derived from the sensor data; store, in the memory, the acoustic data and the one or more frequency domain features for a first time for the first portion of the sensor data set; determine a difference value for the acoustic data and the one or more frequency domain features between the first time and a second time; and store, in the memory, the difference value for the second time.

A fifty fourth embodiment can include the system of the fifty third embodiment, wherein the processor is configured to store the acoustic data and the one or more frequency domain features for the first time and a first depth for the first portion of the sensor data set, and is further configured to: determine a depth difference value for the acoustic data and the one or more frequency domain features between: 1) the first time and the first depth, and 2) the first time and a second depth, and store the acoustic data and the one or more frequency domain features by storing the depth difference value for the first time and the second depth.

A fifty fifth embodiment can include the system of any one of the fifty third or fifty fourth embodiments, wherein the processor is further configured to: denoise the acoustic data to provide a denoised acoustic data prior to identifying the anomaly.

A fifty sixth embodiment can include the system of the fifty fifth embodiment, wherein the processor is configured to denoise the acoustic data by median filtering the acoustic data.

A fifty seventh embodiment can include the system of the fifty sixth embodiment, wherein the processor is further configured to threshold the denoised acoustic data, by replacing sensor data values below a threshold with a zero value.

A fifty eighth embodiment can include the system of any one of the fifty third to fifty seventh embodiments, where the processor is configured to identify the anomaly in the first portion of the data set using the one or more frequency domain features derived from the acoustic data by: identifying the anomaly in the acoustic data set at a first time; comparing, at a second time, the one or more features at the second time with the one or more features at the first time; determining that the one or more feature at the second time are within a threshold difference of the one or more features at the first time; and determining the presence of the anomaly in the acoustic data set at the second time based on the one or more feature at the second time being within the threshold difference of the one or more features at the first time.

A fifty ninth embodiment can include the system of any one of the fifty third to fifty eighth embodiments, wherein the processor is further configured to: populate a second sensor data set with the stored frequency domain features of the first portion of the sensor data set from the memory; and populate the second sensor data set with zero values for the second portion of the sensor data set, wherein the second sensor data set is representative of the anomalies within the sensor data set.

A sixtieth embodiment can include the system of the fifty ninth embodiment, further comprising an output device, wherein the processor is further configured to: present, on the output device, the second sensor data set as a representation of the sensor data set.

A sixty first embodiment can include the system of the sixtieth embodiment, wherein the processor is further configured to: generate one or more averaged data sets, wherein the averaged data sets average two or more readings from the second sensor data; and present, on the output device, at least one of the one or more averaged data sets.

A sixty second embodiment can include the system of any one of the fifth third to sixty first embodiments, wherein the one or more frequency domain features comprise at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof.

A sixty third embodiment can include the system of any one of the fifty third to sixty second embodiments, wherein the sensor readings are obtained from a distributed acoustic sensor.

A sixty fourth embodiment can include the system of the sixty third embodiment, wherein the distributed acoustic sensor comprises a fiber optic cable disposed within the wellbore.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. For example, features described as method steps may have corresponding elements in the system embodiments described above, and vice versa. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1.-24. (canceled)

25. A method of reducing data storage volumes for event detection, the method comprising:
obtaining sensor data, wherein the sensor data is obtained from one or more sensors, and wherein the sensor data comprises measured sensor values through time and location;
determining one or more signal characteristics of the sensor data, wherein the one or more signal characteristics comprise one or more features derived from the sensor data;
storing the sensor data and the one or more signal characteristics of the sensor data at a first time;
determining a difference value between the sensor data and the one or more signal characteristics at the first time and the sensor data and the one or more signal characteristics at a second time; and
storing the difference value for the sensor data and the one or more signal characteristics for the second time.

26. The method of claim 25, wherein the sensor data and the one or more signal characteristics are stored at the first time for a first location, wherein the method further comprises:
determining a difference value between the sensor data and the one or more signal characteristics at the first time and at the first location and the sensor data and the one or more signal characteristics at the first time and at a second location; and
storing the difference value for the sensor data and the one or more signal characteristics for the first time at the second location.

27. The method of claim 25, further comprising:
rounding the difference value for the sensor data and the one or more signal characteristics; and
storing the rounded difference value for the sensor data and the one or more signal characteristics.

28. The method of claim 25, further comprising:
identifying an anomaly in a first portion of the sensor data using one or more features derived from the sensor data,
wherein the sensor data and the one or more signal characteristics of the sensor data at the first time and the difference value for the sensor data and the one or more signal characteristics for the second time are within the first portion of the sensor data, and
wherein a second portion of the sensor data does not contain the anomaly, and
wherein the second portion of the sensor data is not stored in the memory.

29. The method of 25, further comprising:
identifying an anomaly in a first portion of the sensor data using one or more features derived from the sensor data,
wherein the sensor data and the one or more signal characteristics of the sensor data at the first time and the difference value for the sensor data and the one or more signal characteristics for the second time are within the first portion of the sensor data, and
wherein a second portion of the sensor data does not contain the anomaly, and
wherein only zero values are stored for the second portion of the sensor data.

30. The method of claim 29, further comprising:
identifying zero values within the stored data; and
removing the zero values from the stored data.

31. The method of claim 29, further comprising:
populating a sensor data set with the stored one or more signal characteristics of the first portion of the sensor data from the memory;
populating the sensor data set with zero values for the second portion of the sensor data, wherein the sensor data set is representative of the anomalies within the sensor data.

32. The method of claim 31, further comprising:
presenting, on an output device, the sensor data set as a representation of the sensor data.

33. The method of claim 32, further comprising:
generating one or more averaged data sets, wherein the averaged data sets average two or more readings from the sensor data set; and
presenting, on the output device, at least one of the one or more averaged data sets.

34. A system of reducing data storage volumes for event detection, the system comprising:
a memory;
a data reduction program stored in the memory; and
a processor, wherein the data reduction program, when executed on the processor, configures the processor to:
receive sensor data, wherein the sensor data is obtained from one or more sensors, and wherein the sensor data comprises measured sensor values through time and location;
determine one or more signal characteristics of the sensor data, wherein the one or more signal characteristics comprise one or more features derived from the sensor data;
store the sensor data and the one or more signal characteristics of the sensor data at a first time;
determine a difference value between the sensor data and the one or more signal characteristics at the first time and the sensor data and the one or more signal characteristics at a second time; and
store the difference value for the sensor data and the one or more signal characteristics for the second time.

35. The system of claim 34, wherein the sensor data and the one or more signal characteristics are stored at the first time for a first location, wherein the processor is further configured to:
determine a difference value between the sensor data and the one or more signal characteristics at the first time and at the first location and the sensor data and the one or more signal characteristics at the first time and at a second location; and
store the difference value for the sensor data and the one or more signal characteristics for the first time at the second location.

36. The system of claim 34, wherein the processor is further configured to:
round the difference value for the sensor data and the one or more signal characteristics; and
store the rounded difference value for the sensor data and the one or more signal characteristics.

37. The system of claim 34, wherein the processor is further configured to:
identify an anomaly in a first portion of the sensor data using one or more features derived from the sensor data,
wherein the sensor data and the one or more signal characteristics of the sensor data at the first time and the difference value for the sensor data and the one or more signal characteristics for the second time are within the first portion of the sensor data, and
wherein a second portion of the sensor data does not contain the anomaly, and
wherein the processor is further configured not to store the second portion of the sensor data in the memory.

38. The system of wherein the processor is further configured to:
identify an anomaly in a first portion of the sensor data using one or more features derived from the sensor data,
wherein the sensor data and the one or more signal characteristics of the sensor data at the first time and the difference value for the sensor data and the one or more signal characteristics for the second time are within the first portion of the sensor data, and
wherein a second portion of the sensor data does not contain the anomaly, and
wherein the processor is configured to store in the memory only zero values for the second portion of the sensor data.

39. The system of claim 38, wherein the processor is further configured to:
identify zero values within the stored data; and
remove the zero values from the stored data.

40. The system of claim 37, wherein the processor is further configured to:
populate a sensor data set with the stored one or more signal characteristics of the first portion of the sensor data from the memory;
populate the sensor data set with zero values for the second portion of the sensor data, wherein the sensor data set is representative of the anomalies within the sensor data.

41. The system of claim 40 further comprising an output device, wherein the processor is further configured to:
present, on the output device, the sensor data set as a representation of the sensor data.

42. The system of claim 41, wherein the processor is further configured to:
generate one or more averaged data sets, wherein the averaged data sets average two or more readings from the sensor data set; and
present, on the output device, at least one of the one or more averaged data sets.

43.-64. (canceled)

65. The method of claim 25, wherein the sensor data comprises acoustic data obtained within a wellbore, wherein the acoustic data comprises sensor readings for a plurality of depths along the wellbore and for a plurality of time periods.

66. The system of claim 34, wherein the sensor data comprises acoustic data obtained within a wellbore, wherein the acoustic data comprises sensor readings for a plurality of depths along the wellbore and for a plurality of time periods.
